(19) United States
(12) Patent Application Publication
(10) Pub. No.: US 2024/0168777 A1
(43) Pub. Date: May 23, 2024

(54) USER INTERFACE FOR TELEPHONIC SERVICES

(71) Applicant: State Farm Mutual Automobile Insurance Company, Bloomington, IL (US)

(72) Inventors: Michelle DeLynn Adler, Sugar Hill, GA (US); Steve Stought, Suwanee, GA (US); Seil Cho, Sugar Hill, GA (US); Kelly Knapp, Bloomington, IL (US); Song Zheng, Duluth, GA (US); Christopher David Sharp, Dunwoody, GA (US); Soumya Ranjan Singh, Normal, IL (US); Arteen Ghafourikia, Alpharetta, GA (US); Cagatay Azkin, Suwanee, GA (US); Kevin Scott Lenz, Bloomington, IL (US); Joshua Zaks, Alpharetta, GA (US)

(21) Appl. No.: 18/513,293

(22) Filed: Nov. 17, 2023

Related U.S. Application Data
(60) Provisional application No. 63/521,541, filed on Jun. 16, 2023.
(60) Provisional application No. 63/469,667, filed on May 30, 2023.
(60) Provisional application No. 63/426,706, filed on Nov. 18, 2022.

(51) Int. Cl. G06F 9/451; G06Q 30/0645; G06Q 40/08

(52) U.S. Cl. CPC G06F 9/451; G06Q 30/0645; G06Q 40/08

(57) ABSTRACT

In the course of booking a vehicle rental on behalf of the claimant, a claim associate needs to submit a variety of information to multiple private hosted service APIs and public hosted service APIs. Conventionally, the claim associate must request, transcribe, and manually input this information on a client computing system during telephonic services, resulting in substantial silences over the phone call decreasing quality of the claimant's service experience. A multi-API interface is provided, which configures the client computing system to anticipate information which the claim associate will need, based on a type of claimant, to send to multiple APIs, assemble this information from a variety of data records, and present this information to the claim associate, using persistent interface elements and flow control elements allowing the claim associate to review and select information to send to multiple APIs with minimal interruption in the service flow of telephonic services.

### CROSS-REFERENCE TO RELATED APPLICATIONS

This application is a nonprovisional of, and claims priority to, U.S. Provisional Patent Application No. 63/426,706, entitled “PRIVATE AND PUBLIC HOSTED SERVICE MULTI-API INTERFACE FOR TELEPHONIC SERVICES,” filed on Nov. 18, 2022, U.S. Provisional Patent Application No. 63/469,667, entitled “USER INTERFACE FOR TELEPHONIC SERVICES,” filed on May 30, 2023, and U.S. Provisional Patent Application No. 63/521,541, entitled “USER INTERFACE FOR TELEPHONIC SERVICES,” filed on Jun. 16, 2023, the entireties of which are incorporated herein by reference.

### BACKGROUND

In the course of insurance claim adjustment, claim associates employed by insurers provide a variety of remote telephonic services to policy claimants during the process of determining coverage, investigating liability, and settling claims. Policy claimants may include insured policy participants named in an automobile insurance policy of the insurer covering an insured vehicle, as well as external claimants filing for damages caused by the insured vehicle (e.g., due to an accident with the insured vehicle). The external claimants may include occupants in other vehicles, pedestrians, and/or passengers in the insured vehicle not covered under the insurance policy of the insured vehicle. For automobile insurance policies in particular, policies can cover the expense of rental vehicles to temporarily replace insured vehicles of policy claimants. Consequently, claim associates can be responsible for telephonically procuring a rental vehicle for a policy claimant to fulfill a claim by the policy claimant for vehicle rental coverage, while the policy claimant is without transportation.

Insurance claim associates perform several tasks while providing such a telephonic service to a policy claimant. These tasks include accessing a private hosted service to review a claim filed by a policy claimant, accessing a private hosted service to review cause-of-loss data, accessing a private hosted service to review information of a vehicle policy claimant, accessing a private hosted service to review coverage of an insurance policy, accessing a private hosted service to determine claim rental reimbursement eligibility, accessing a private hosted service to determine a repair facility which has received an insured vehicle repair assignment, accessing a private hosted service to determine a rental agency which has received a vehicle rental assignment, and/or accessing rental booking services of multiple rental agencies. Amidst these tasks, insurance claim associates also access and review map data to determine the locations of rental agencies, types of rental cars, and their accessibility from a location of the policy claimant.

In order to successfully provide service to a policy holder or an external claimant who is temporarily without transportation, the insurance claim associate may, on behalf of the policy claimant, book a satisfactory vehicle rental according to preferences and a location of the policy claimant over the course of one phone call. Therefore, while speaking with the policy claimant, the insurance claim associate can be responsible for submitting a claim for rental reimbursement on behalf of the policy claimant, collecting preferences and location of the policy claimant, evaluating multiple rental agencies, their locations, and their selections of available vehicles based on location and preferences of the policy claimant, booking a rental and assigning the rental to the policy claimant, conveying rental assignment information to a rental agency, performing post-rental adjustments to the rental (e.g., extending a rental or terminating a rental), and the like. As a result of the insurance claim associate's intermediary role between a policy claimant, an insurer, multiple rental agencies, and the like, the associate must convey information between non-interoperable hosted service application programming interfaces (APIs) belonging to multiple parties, and enter into binding transactions with multiple parties, while effectively communicating with a policy claimant to successfully remedy the policy claimant's lack of transportation.

Currently available enterprise software tools configure computing systems to assist an insurance claim associate in performing various tasks, but such software tools present the above-described information from multiple sources in non-unified and disorganized fashions, requiring a claim associate to manually organize information returned from multiple APIs. For every API accessed, conventional software services spawn a separate window. Claim associates must provide manual input to access each API of a private hosted service, whereupon conventional software services spawn, one by one, windows corresponding to each API independent of each other.

As the software service spawns more windows, the windows begin to visually overlap on a display screen due to limited display space and large numbers of APIs accessed. Consequently, claim associates need to manipulate and organize each window so that the claim associate can view respective information presented on each window in a logical fashion.

Insurance claim associates can benefit from improved software tools to facilitate their workflow while providing telephonic services to policy claimants.

### SUMMARY

In an example of the present disclosure, a method includes providing, by a client computing system, a frontend application including a first rendering of a user interface (UI), the first rendering of the UI comprising: a persistent interface element, and a flow interface element including a first plurality of sub-elements, the frontend application selectively displaying a first flow control element in the first rendering based on a current step of a service flow. The method further includes receiving, by the client computing system, information indicative of an interaction with the first flow control element, wherein the information is based on an input received from a user of a user device, and providing, by the client computing system and based on the information, a second rendering of the UI, the second rendering comprising: the persistent interface element, the flow interface element including a second plurality of sub-elements, and a second flow control element associated with a next step of the service flow.

In another example of the present disclosure, a system is configured for providing, on the display, a frontend application including a first rendering of a user interface (UI), the first rendering of the UI comprising: a persistent interface element, a flow interface element including a first plurality of sub-elements, and a first flow control element based on a current step of a service flow. The system is further configured for receiving information indicative of an interaction with the first flow control element, wherein the information is based on an input received from a user of a user device, and clearing the first plurality of sub-elements from the flow interface element in response to the interaction. The system is yet further configured for providing, based on the information, a second rendering of the UI, the second rendering comprising: the persistent interface element, the flow interface element including a second plurality of sub-elements, and a second flow control element associated with a next step of the service flow.

In a further example of the present disclosure, a computer-executable storage medium storing computer-readable instructions executable by one or more processors, that when executed by the one or more processors, cause the one or more processors to perform operations comprising: providing a frontend application including a first rendering of a user interface (UI) comprising a persistent interface element, a flow interface element including a first plurality of sub-elements, and a first flow control element based on a current step of a service flow. The computer-executable storage medium storing computer-readable instructions is further configured for receiving information indicative of an interaction with the first flow control element, wherein the information is based on an input received from a user of a user device, clearing the first plurality of sub-elements from the flow interface element in response to the interaction, and providing, based on the information, a second rendering of the UI, the second rendering comprising: the persistent interface element, the flow interface element including a second plurality of sub-elements, and a second flow control element associated with a next step of the service flow.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a schematic diagram of a networked computing environment implementing example embodiments of the present disclosure.

FIGS. 2A through 2J illustrate examples of different views of a multi-API interface which a frontend application configures one or more processors of a client computing system to render on a display of the client computing system, according to example embodiments of the present disclosure.

FIG. 3 illustrates an example flowchart of dynamically generating a message to be provided to a claimant, according to example embodiments of the present disclosure.

FIG. 4 illustrates an example computing host for implementing the processes and methods described herein for implementing private hosted services.

FIG. 5 illustrates an example client computing system for implementing the processes and methods described herein as configured by a frontend application.

FIGS. 6A and 6B illustrate a flowchart of an example interaction between a computing system of an insurer and a computing system of a vendor during a vehicle rental transaction.

FIG. 7 illustrates a schematic diagram of an example computing architecture implementing example embodiments of the present disclosure.

### DETAILED DESCRIPTION

Systems and methods discussed herein are directed to providing a user interface for a computing system, and more specifically a multi-application programming interface (“API”) interface which configures a computing system to communicate with APIs of multiple hosted services, including claim filing service APIs, cause-of-loss service APIs, vehicle policy participants service APIs, claim coverage service APIs, coverage eligibility service APIs, service provider lookup service APIs, repair management service APIs, rental management service APIs, rental booking service APIs, rental agency lookup service APIs, and the like. Systems and methods discussed herein are further directed to configuring a computing system to anticipate claimant-specific possible responses which a claim associate will need to send to multiple public hosted service APIs and private hosted service APIs during a telephonic service flow, so that a claim associate can sequentially operate flow control elements of a common user interface to send claimant responses to those APIs without inputting text and being minimally distracted by manual operations of a computing system while providing telephonic services to policy claimants.

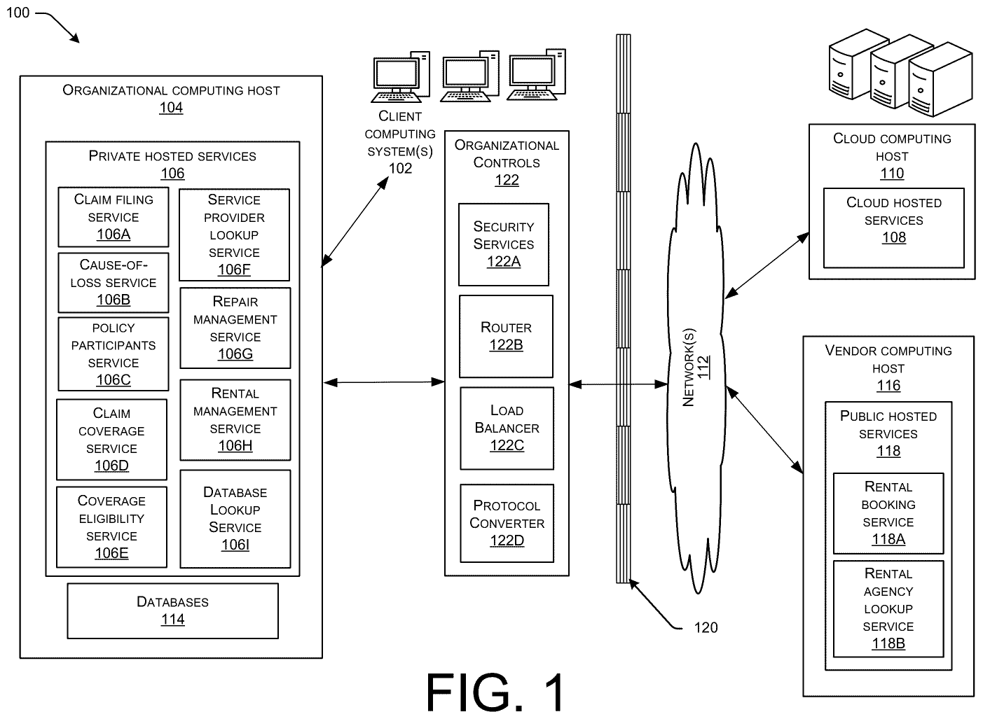

FIG. 1 illustrates a schematic diagram of a networked computing environment 100 according to example embodiments of the present disclosure. In some examples, the computing environment 100 may include client computing systems 102 communicating with organizational computing host(s) 104 (e.g., operated by an organization, such as an insurer) hosting various private hosted services 106 for internal use of organizational employees. The client computing systems 102 may communicate with the organizational computing host(s) 104 over one or more private networks (such as an organizational intranet restricting access to only the client computing systems 102 authenticated by security credentials of the organization) and/or one or more public networks (such as the Internet). In other examples, one or more of the private hosted services 106 may instead be hosted, as cloud hosted services 108, on a cloud computing host 110 accessible to the client computing systems 102 via a network 112.

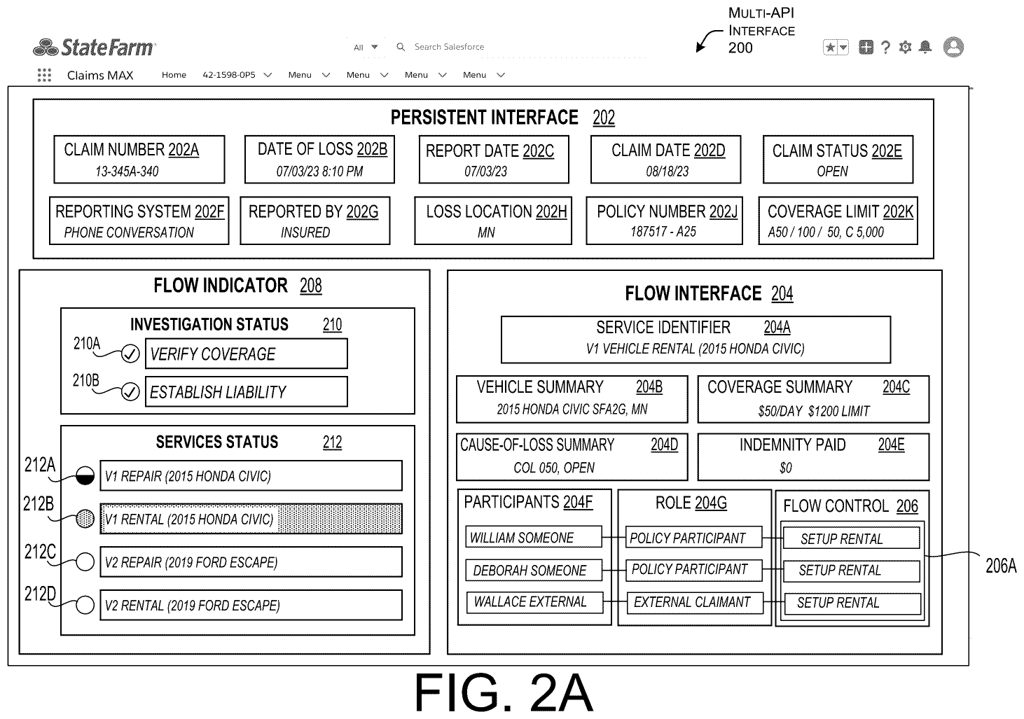

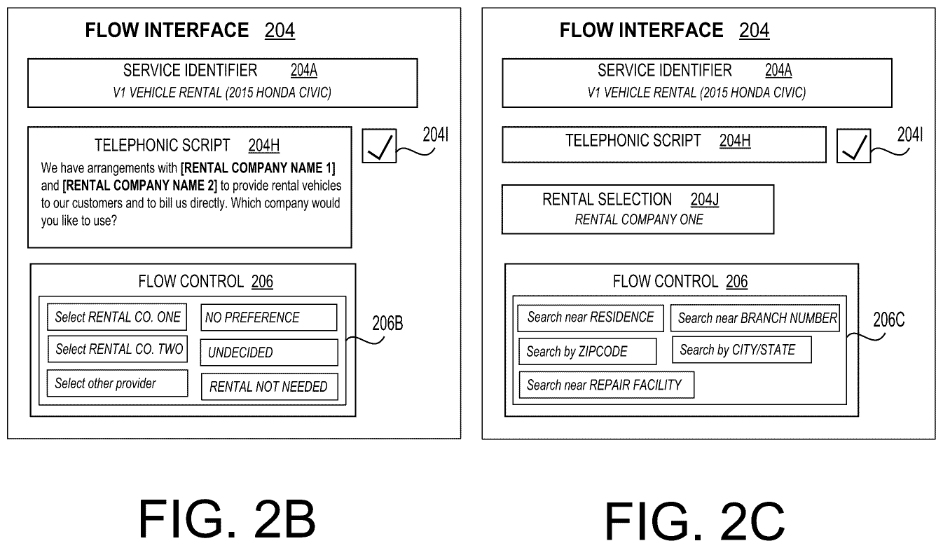

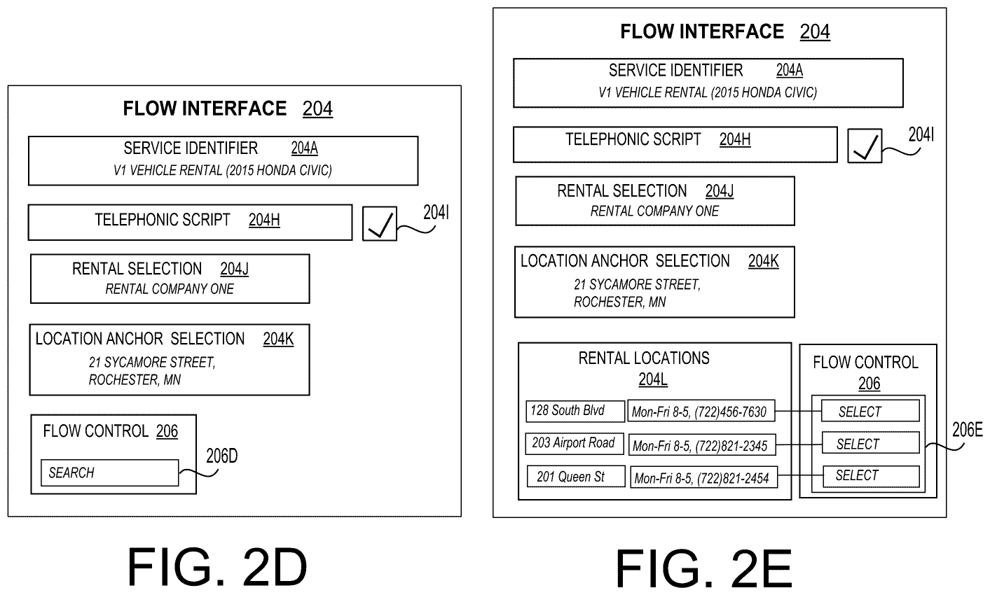

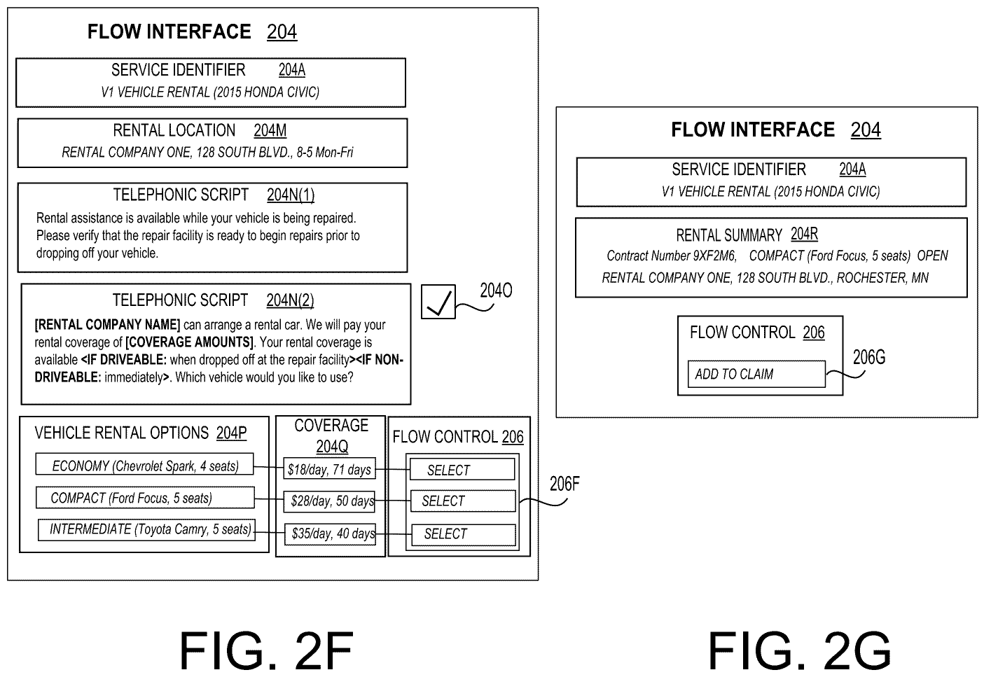

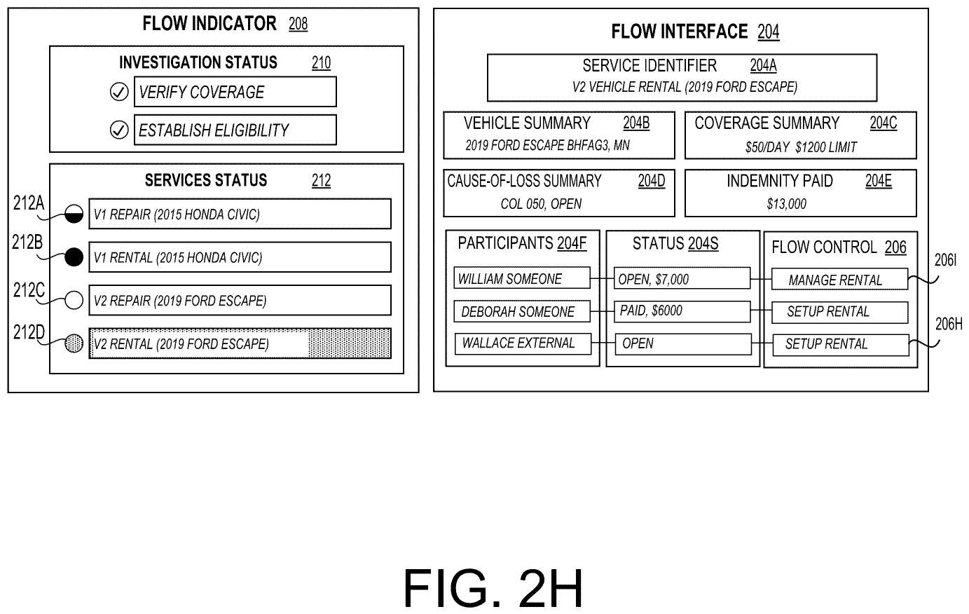

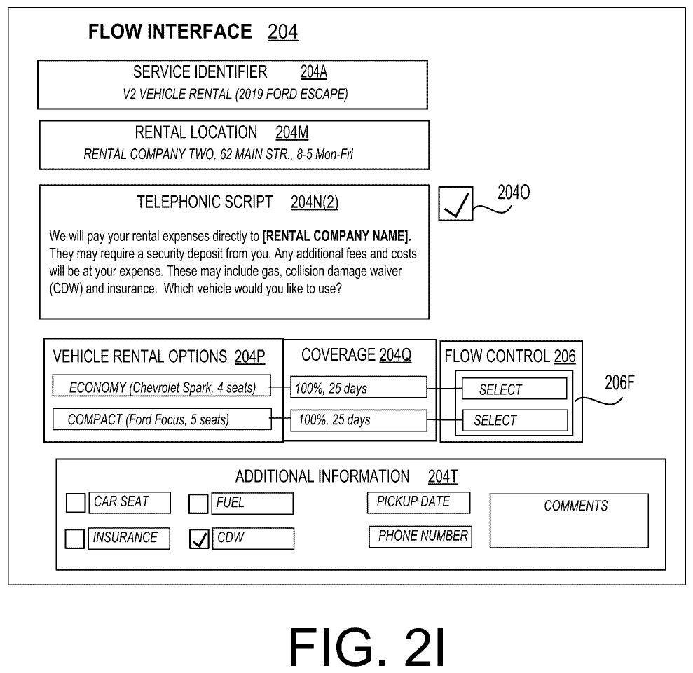

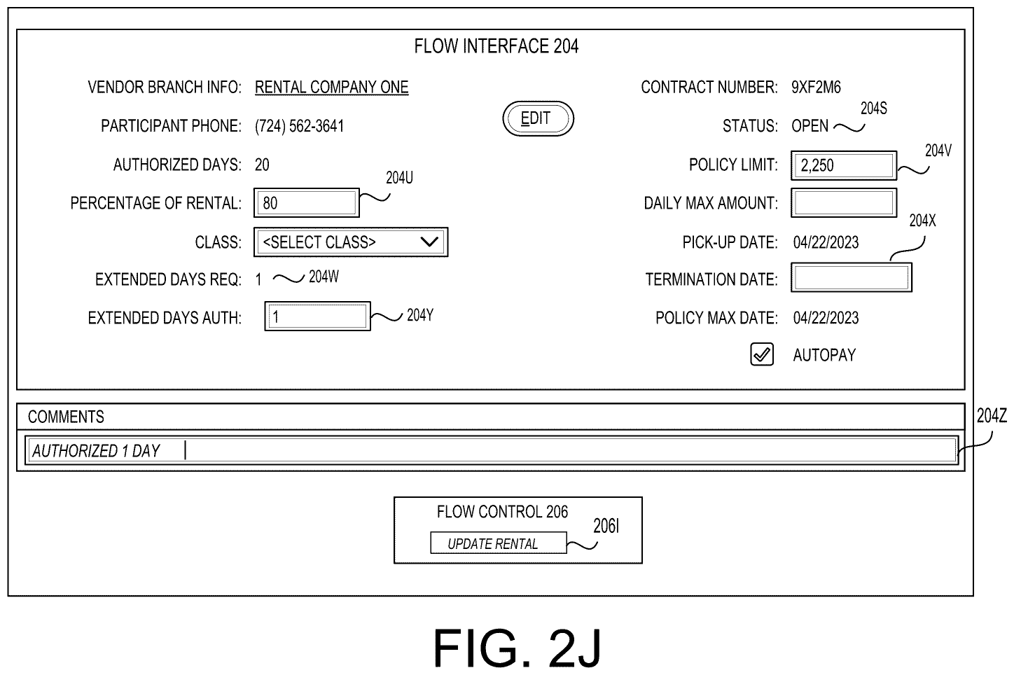

The client computing systems 102, operated by any number of users (e.g., claim associates handling calls from claimants) possessing security credentials of the insurer, can run a set of computer-executable instructions which configure the client computing systems 102 to run a user-operable frontend (subsequently referred to as a “frontend application,” for brevity) to connect to the networked computing hosts (such as the organizational computing host 104 and/or the cloud computing host 108). The frontend application may enable a claim associate to select a workflow (or service flow) based on a type of claimant (e.g., a policy participant named in an insurance policy of the insurer, or an external claimant filing a claim against a policy participant), and user interface (UI) elements of the frontend application may be configured dynamically to handle the workflow specific to the type of claimant and a step of the workflow that is being performed, as described with reference to FIGS. 2A-2J. For example, if the claim associate indicates that the claimant (e.g., on the phone) is a policy participant calling to arrange transportation while an insured vehicle is being repaired, the UI elements of the frontend application may be configured to provide a workflow corresponding to arranging a vehicle rental for a policy participant of the insurance policy. Whereas, if the claim associate indicates that the claimant is an external claimant, the UI elements of the frontend application may be configured to provide a workflow corresponding to an external claimant. The computer-executable instructions can further configure the client computing systems 102 to send a request to the organizational computing hosts 104 and/or the cloud computing host 108, to cause the computing hosts 104, 108, to perform operations as shall be described subsequently.

According to example embodiments of the present disclosure, the private hosted services 106 can include at least a claim filing service 106A, a cause-of-loss service 106B, a policy participants service 106C, a claim coverage service 106D, a coverage eligibility service 106E, a service provider lookup service 106F, a repair management service 106G, and a rental management service 106H. The private hosted services 106 may provide different functionality based on the workflow selected by the claim associate corresponding to the type of claimant. As examples, the repair management service 106G may be called to enable repair assignments to be made by the claim associate (e.g., assigning a repair shop for vehicle repairs), and the rental management service 106H may be called to enable rental assignments to be made by the claim associate (e.g., assigning a rental car for the claimant). In some examples, one or more of the private hosted services 106 may not be called, may return different data, may skip a step, may use different default values of parameters, etc. The private hosted services 106 can further include a database lookup service 106I for accessing and retrieving data from insurer's databases 114 (including, by way of example, policy participant databases, policy databases, policy coverage databases, cause-of-loss databases, and the like). The databases 114 may be implemented as any relational or non-relational database (wherein a set of data records, each record containing some number of fields, can be stored according to any suitable database schema as known to persons skilled in the art), and may be stored on the organizational computing host 104 (as shown), on the cloud computing host 110, or on other distributed storage systems.

In examples, the client computing system 102 can connect to an organizational computing host 104 over a private network connection, and call the API of a private hosted service 106 hosted on the organizational computing host 104 to configure the organizational computing host to perform a function provided by the private hosted service 106. Each of the private hosted services 106 can provide a different API which can be called to configure the organizational computing hosts 104 to perform different functions. As an example, the database lookup services 106I of the private hosted services 106 may be configured to create and update data records of the insurer's databases 114 by calls to an application programming interface (“API”) of the private hosted services 106 to invoke database operations. The database lookup services 106I may perform operations upon data records of one or more databases 114 including policy participant data records, insurance policy data records, and policy coverage data records. These characterizations should be understood as merely distinguishing several different types of data records from each other, without limiting fields and otherwise any other data that each different type of data record can contain. Each such record as described herein should be understood as referring to data structures which can be implemented according to a variety of possible database schemas.

Organizational computing hosts 104 can be configured to perform operations using data records of one or more databases 114, including creating data records, searching data records, retrieving data records, and updating data records. The present disclosure should not be understood as limiting the implementation of these data records as various possible data structures according to various schemas.

Furthermore, the client computing systems 102 can connect, over one or more public networks (such as the network(s) 112), to one or more public computing hosts not under the control of the organization. The one or more public computing hosts can include a vendor computing host 116 operated by another organization, such as a rental agency. The vendor computing host 116 can host a public hosted service 118, such as a rental booking service 118A, and a rental agency lookup service 118B.

Different vendor computing hosts 116 can be operated by different third parties other than the organization operating the insurer hosting network, and different public hosted services 118 can be services provided by different third parties. Such public hosted services 118 do not restrict access to client computing systems 102 authenticated by security credentials of an organization; any client computing system 102 can connect to the vendor computing hosts 116 over a public network connection, such as over the network(s) 112, and call an API of a public hosted service 118 to configure the vendor computing hosts 116 to perform a function provided by the public hosted service 118.

In the event that a claim associate employed by an insurer is engaged in providing telephonic services to a policy claimant to fulfill a claim by the policy claimant for vehicle rental reimbursement, the claim associate can operate a client computing system 102 to cause one or more processors of the client computing system 102 to perform a number of operations while speaking to the policy claimant by phone. It should be understood that a policy claimant may or may not be a policy participant who qualifies for vehicle rental reimbursement. Furthermore, a qualifying policy participant may or may not be the policyholder of a vehicle policy, as shall be described in further detail subsequently with reference to a vehicle policy participants service.

First, in the event that the policy claimant verbally requests the claim associate to book a vehicle rental on behalf of the policy claimant, the policy claimant generally does not know which vehicles may be available for rental at which offices of which rental agencies, does not know which offices of which rental agencies are geographically near the location of the policy claimant (or near the location of a repair facility where the insured vehicle is being repaired), and does not know the rental options and pricing offered by each rental agency. The policy claimant may have some general preferences as to vehicle type and pricing for the rental to be booked, but it is more productive for the rental associate to ask the policy claimant for this information after ascertaining rental agencies near the policy claimant, rental options, and rental pricing.

After the policy claimant requests a vehicle rental booking, the claim associate may, while maintaining the ongoing phone call with the policy claimant, operate a client computing system 102 to cause one or more processors of the client computing system 102 to:
(i) access a private API of the cause-of-loss service 106B, to either look up a cause-of-loss record for an insured vehicle for which the policy claimant has submitted an insurance claim (e.g., using the database lookup service 106I), or create a cause-of-loss record for an insured vehicle for which the policy claimant is submitting an insurance claim e.g., in the databases 114;
(ii) access a private API of the policy participants service 106C, to look up (e.g., from the databases 114 using the database lookup service 106I) participants of a vehicle insurance policy, where participants, depending on vehicle policy terms, can include any, some, or all of a named insured identified by the vehicle policy, an additional insured not named by the vehicle policy, a claimant submitting a claim under the vehicle policy, a driver of an insured vehicle other than an insured, a driver of another vehicle other than the insured vehicle, and the like;
(iii) access a private API of the coverage eligibility service 106E, to determine whether a vehicle policy participant is eligible for vehicle rental reimbursement;
(iv) access a public API of the rental booking service 118A, to submit information to public computing hosts operated by a vehicle rental agency in order to book a vehicle rental on behalf of a policy claimant;
(v) access a private API of the rental management service 106H, to display and to assign an existing vehicle rental booked on behalf of a policy claimant to the policy claimant; and
(vi) access a public API of a rental agency lookup service, to look up locations of one or more vehicle rental agencies which are geographically closest to one or more target locations. The lookup locations methods include submitting a city and state desired location, or similarly a zip/postal code; and the like.

As discussed, in some examples, one or more of the private hosted services 106 may be implemented as the cloud hosted services 108 on the cloud computing host 110. In some examples, data exchange between computing systems of the organization (such as the organizational computing host 104 and the client computing systems 102) and the cloud computing host 110, as well as the vendor computing host 116, may traverse a firewall 120, and be controlled by organizational controls 122. For example, security services 122A may include hardware and/or software configured to control data transmitted across the firewall 120, including data received from the vendor computing host 116 and the cloud computing host 110, and data sent by the organizational computing host 104 and the client computing systems 102. The organizational controls 122 may also include a router 122B configured for directing data to appropriate services and/or computing systems within the organization. In some examples, the organizational computing host 104 may comprise multiple computing devices, each providing the private hosted services 106. In such examples, the organizational controls 122 may include a load balancer 122C configured to direct data to the private hosted services 106 on a computing device of the organizational computing host 104 based on availability of the private hosted services 106 on the computing device.

In various examples, services 106A-106I of the private hosted services 106, implementations of the services 106A-106I as the cloud hosted services 108, and/or the public hosted services 118 may provide APIs adhering to different protocols or architectural principles. For example, the APIs may be representational state transfer (REST) APIs returning data in a variety of formats, such as HTML, XML, plain text, JSON, etc., over the network (2) 112 using HTTP (hypertext transfer protocol) protocols. In other examples, the APIs may adhere to simple object access protocol (SOAP), where data is returned as XML documents. different data communication protocols may be used for data transfers between the cloud computing host 110, the vendor computing host 116 and the organizational computing host 104. In some examples, the organizational controls 122 may implement a protocol converter 122D configured to transform data based on a type of API and provide interoperability between APIs adhering to different protocols.

In examples, claim associate may operate the client computing system 102 to cause one or more processors of the client computing system 102 to access many or all of the above-mentioned private hosted service 106 APIs, cloud hosted services 108 APIs, and public hosted services 118 APIs. According to example embodiments of the present disclosure, a multi-API interface configures one or more processors of a client computing system to communicate with APIs of private and public hosted services as described above, including claim filing service APIs, cause-of-loss service APIs, vehicle policy participants service APIs, claim coverage service APIs, coverage eligibility service APIs, service provider lookup service APIs, rental management service APIs, rental booking service APIs, rental agency lookup service APIs; as well as configuring one or more processors of a client computing system to anticipate claimant-specific possible responses which a claim associate will need to send to multiple public hosted service APIs and private hosted service APIs during a telephonic service flow, so that a claim associate can sequentially operate flow control elements of a common user interface to send claimant responses to those APIs without inputting text and being minimally distracted by manual operations of a client computing system while providing telephonic services to policy claimants, thus enhancing flow of a telephonic conversation with a policy claimant.

FIGS. 2A through 2J illustrate examples of different views of a multi-API interface 200 which a frontend application configures one or more processors of a client computing system to render on a display of the client computing system 102, according to example embodiments of the present disclosure. According to example embodiments of the present disclosure, a frontend application is hosted on one or more networked computing hosts communicating over one or more private networks (such as an organizational intranet restricting access to client computing systems authenticated by security credentials of an organization), or on cloud computing services communicating over one or more public networks. It should be understood that the client computing systems 102 may be part of the insurer computing network, or may be part of another computing network operated by the same organization, restricting access to client computing systems authenticated by security credentials of the same organization. Any number of networked computing hosts can individually or collectively host the frontend application accessible over a private or public network, and communicate with the client computing system 102 operated by a claim associate.

In the course of a claim associate performing routine duties, the claim associate can receive a telephonic call from a claimant, the claimant submitting a claim for vehicle rental coverage under a vehicle insurance policy covering a vehicle loss. After speaking to the claimant, the claim associate identifies the claimant by name and identifies the vehicle policy by a policy number.

The claim associate operates a client computing system to cause one or more processors of the client computing system to access, over a network connection of one or more private networks, networked computing hosts hosting the frontend application, and run the frontend application on the client computing system. As the client computing system runs the frontend application, the telephonic call between the claim associate and the claimant continues according to a service flow, as shall be described subsequently.

The claim associate operates the client computing system to input the claimant name and the policy number into the multi-API interface, and to cause one or more processors of the client computing system to pass the claimant name and the policy number to one or more APIs of one or more private hosted services (subsequently “private hosted service APIs,” for brevity) of an insurer computing network. It should be understood that the claim associate may operate the client computing system to input some text at this time, but does not need to subsequently input further text during a telephonic service flow as shall be described subsequently.

The one or more private hosted service APIs can include a claim filing service API, which can return a filed claim data record including one or more fields describing a vehicle loss claim filed under an insurance policy (to be described in further detail subsequently); can include a cause-of-loss service API, which can return a cause-of-loss data record including one or more fields describing cause-of-loss investigation of a vehicle loss; can include a vehicle policy participants service API, which can return one or more policy participants data record(s) including one or more fields describing participants of a vehicle policy; can include a claim coverage service API, which can return one or more coverage data record(s) including one or more fields describing coverage limits for each participant of a vehicle policy; and can include a coverage eligibility service API, which can return one or more eligibility data record(s) including one or more fields describing whether a participant of a vehicle policy is eligible to file a claim for vehicle rental reimbursement.

The one or more processors of the client computing system can cause one or more private hosted service APIs to return the above initially returned data records before the claim associate proceeds to speak further to the claimant according to a service flow.

Over the course of a service flow, to book a vehicle rental on behalf of the claimant over the phone call, the claim associate reviews information returned from one or more APIs on a display of the client computing system, including options a claimant can select; selects an option spoken by a claimant over a phone call using an input device of the client computing system, without needing to transcribe the option; announces information returned from one or more APIs to a claimant over the phone call; and requests the claimant answer one or more questions and selects one or more answers using an input device of the client computing system, without needing to transcribe the answers. For brevity, these operations and tasks performed over the course of the service flow can be collectively referred to subsequently as “service flow actions.”

During the entire course of this service flow, the claim associate may need to refer to the contents of the above data records in addition to any other data later input or returned, since the contents of the above initially returned data records may pertain to the other data later input and returned. For brevity, the above initially returned data records, including filed claim data records, cause-of-loss data records, policy participants data records, coverage data records, and eligibility data records can be collectively referred to subsequently as “service flow parameters.”

According to example embodiments of the present disclosure, to facilitate the claim associate performing service flow actions while minimizing distractions which may lead to lengthened silences over the phone call, the frontend application configures one or more processors of the client computing system to render a multi-API interface 200, and configures a display of the client computing system 102 to display the rendered views of the multi-API interface 200 illustrated in FIGS. 2A through 2J, one at a time, over the course of the claim associate performing service flow actions.

As shown in FIG. 2A, the rendered multi-API interface 200 includes one or more persistent interface elements 202 and a flow interface element 204. The persistent interface elements 202 include at least some of the service flow parameters as described above, and the persistent interface elements 202 continue to be displayed and include the service flow parameters throughout the rendered views of FIGS. 2A through 2J (though not shown in FIGS. 2B through 2J), since the claim associate may need to refer to at least some of the service flow parameters throughout performing the service flow actions.

In contrast, the flow interface element 204 includes different content sub-elements (e.g., for content presentation) and different interactive sub-elements throughout each of FIGS. 2A through 2J. In each different rendered view of the multi-API interface 200, the flow interface element 204 can include one or more interactive sub-elements which configure one or more processors of the client computing system to, upon detecting certain inputs or combinations of inputs at these interactive sub-elements from an input device of the client computing system, cause one or more processors of the client computing system to render a different view of the multi-API interface 200, causing the flow interface element 204 to include different content and different interactive sub-elements, while the persistent interface elements 202 remain the same. In particular, the examples in FIGS. 2A through 2I illustrate sub-elements of the flow interface element 204 for handling processing of claims from insured policy participants named in an automobile insurance policy of the insurer or external claimants making claims against a policy participant of an automobile insurance policy of the insurer. Further, the multi-API interface 200 may include interactive sub-element(s) which configure one or more processors of the client computing system to render a different view of the multi-API interface 200. Regardless of which view and which drawing it is illustrated in, and regardless of its appearance and interaction modality, any such interactive sub-element(s) can be referred to subsequently as a “flow control element 206,” for brevity.

To prevent drawing away attention of the claim associate from speaking to the claimant over a phone call, the flow control element(s) 206 do not require the claim associate to input text into an input device of the client computing system in order to cause different views of the multi-API interface 200 to be rendered. Instead, a multi-API interface 200 according to example embodiments of the present disclosure can include flow control elements 206 which anticipate and present multiple possible options that the claim associate will need to select during telephonic services, rather than requiring the claim associate to input those options on the fly using text input.

To anticipate options, the frontend application configures one or more processors of a client computing system to retrieve, from public hosted service APIs and private hosted service APIs, claimant-specific possible options which a claim associate will need to send to multiple public hosted service APIs and private hosted service APIs during a telephonic service flow. For certain responses which a claim associate will need to solicit from a claimant during a telephonic conversation, such as preferences for vehicle rental agencies, options may be limited by claimant-specific geographical proximity. In other examples, the claim associate may be provided with options to adjust and/or change search parameters, allowing the claim associate to search for vehicle repair or rental agencies using any geographic location as anchor and setting any search radius around the anchor. Therefore, the client computing system can be configured to retrieve such claimant-specific options which can be given as possible responses, so that the claim associate can operate the client computing system to view and select claimant-specific possible options based on the claimant's response, rather than verbally request and transcribe a claimant response.

In this fashion, the claim associate will not need to transcribe information spoken by a claimant over a telephonic conversation into multiple windows and multiple user interfaces using a text input device to input text; transfer information across multiple windows and/or multiple user interfaces from one to another; request the claimant answer one or more questions and inputting one or more answers into multiple windows and multiple user interfaces; and the like. Performing each of these operations, while avoiding manual error (and particularly while inputting text), requires substantial attention, and a claim associate may be unable to maintain flow of a telephonic conversation with the claimant while performing these operations. By preventing breaking the flow of a telephonic conversation such distractions, substantial silences over the phone call (or substantial periods of text input sounds without speaking) are reduced, and quality of the claimant's service experience is improved.

Furthermore, the multi-API interface 200 includes a flow indicator element 208. The flow indicator element 208 can indicate an investigation status 210 and a service status 212. The investigation status 210 may indicate whether an insurance coverage under which the claim being processed has been verified (e.g., by checkbox 210A) and/or whether the claim associate has completed service flow actions for establishing liability (e.g., by checkbox 210B), which may be based on a call to the API of the cause-of-loss service 106B. The service status 212 element may indicate for which, among several service APIs, the claim associate has completed all service flow actions; for which, among several service APIs, the claim associate has partially completed service flow actions; for which, among several service APIs, the claim associate has not completed service flow actions; and for which, among several service APIs, the claim associate is currently performing service flow actions.

By way of example, as shown in FIG. 2A, it should be understood that the claim associate has partially completed service flow actions for a repair management service API for the insured vehicle 212A, has initially not completed service flow actions for a rental management service API for the policy participant(s) 212B, and has, ultimately, completed service flow actions for a rental management service API for the policy participant(s) 212B (as illustrated in FIG. 2H). Though not shown in FIGS. 2B through 2G, the flow indicator element 208 continues to be rendered in the multi-API interface 200, indicating a partially completed service flow actions for a rental management service API for the policy participant(s) 212B. In addition, across FIGS. 2A through 2H, service flow actions for repair management service API for an external claimant's vehicle 212C, and for rental management service API for the external claimant 212D are shown as not started. It should be understood that, for the purpose of understanding example embodiments of the present disclosure, not all service flow actions for all service APIs need be described in detail.

FIG. 2A illustrates a first view of a multi-API interface 200 rendered by one or more processors of a client computing system configured according to example embodiments of the present disclosure.

As illustrated in FIG. 2A, one or more processors of a client computing system are configured to render persistent interface elements 202 including service flow parameters such as filed claim data records and coverage data records. One or more processors of a client computing system are configured to render claim data records at least in part to indicate a claim number 202A, a date and time of loss 202B, a loss reporting date 202C, a claim date 202D, a claim or subrogation status 202E, a reporting system 202F, a reporting party 202G, and a loss location 202H. The persistent interface elements 202 may also render a coverage data record at least in part to indicate a policy number 202J and coverage limits 202K. Though not shown in FIGS. 2B-2J, the claim data records and the coverage data records are displayed persistently in the persistent interface elements 202 on a display of the client computing system, as shown in FIG. 2A, so that a claim associate can view the nature of a filed claim.

As illustrated in FIG. 2A, one or more processors of a client computing system are configured to render a flow interface element 204 containing sub-elements, which may include sub-elements such as a service identifier 204A indicating the service the claim associate is currently performing service flow actions for, a vehicle summary 204B indicating information about an insured vehicle, a coverage summary 204C indicating coverage for repairs or rentals, a cause-of-loss data summary 204D, and an indemnity paid 204E indicating a current value of indemnity already paid for the claim identified in the claim number 202A. The flow interface element 204 may also include one or more policy participants or external claimants data record(s) 204F indicating a role 204G for each name (e.g., whether a policy participant or external claimant, whether a driver or owner of a listed vehicle, etc.). For example, the cause-of-loss data summary 204D may include, at least in part, data indicating status of an open cause-of-loss investigation for a vehicle loss, and the coverage summary 204C may include, at least in part, fields indicating eligibility of the selected participant in the participant data record(s) 204F for vehicle rental coverage.

As illustrated in FIG. 2A, a flow control element 206, which may be associated with or embedded in the flow interface 204, includes one or more interactive rental setup links 206A, where one or more processors of the client computing system are configured to render one rental setup link for each participant of the policy participant data record(s) who is also eligible for vehicle rental coverage, based on the policy participants data record(s) and the eligibility data record(s). Selection of a link of the rental setup link(s) 206A by the claim associate configures one or more processors of the client computing system to render an updated view of the flow interface 204 illustrated in FIG. 2B.

A rental setup link is not rendered for any participant who is not eligible for vehicle rental coverage according to the policy participant data record(s) and the eligibility data record(s). Therefore, upon reviewing those participants displayed as having rental setup links, the claim associate determines whether the claimant has a rental setup link; if affirmative, the claim associate can request the claimant to answer whether to file a claim for vehicle rental coverage.

In the above fashion, the selective display of flow control elements facilitates the claim associate's determination of eligible participants; the claim associate does not need to separately review, in three separate user interfaces, cause-of-loss data records to determine that the cause-of-loss investigation is open; policy participants data records to determine that the claimant is among the policy participants; and eligibility data records to determine that the claimant is eligible for vehicle rental coverage.

In the event the claimant answers affirmatively, the claim associate operates the client computing system to interact with the rental setup link 206A displayed for a participant who is the claimant, causing the one or more processors of the client computing system to render a view of the flow interface 204 illustrated in FIG. 2B.

FIG. 2B illustrates a second view of the flow interface 204 rendered by one or more processors of a client computing system configured according to example embodiments of the present disclosure. Though not shown in FIG. 2B, a display of the client computing system is configured to continue to display the persistent interface elements 202 and the flow indicator elements 208 including substantially similar elements as illustrated in FIG. 2A.

As illustrated in FIG. 2B, one or more processors of a client computing system are configured to clear one or more previously described sub-elements from the rendered flow interface element 204 of FIG. 2A, then newly render a flow interface element 204 containing sub-elements, the sub-elements including a telephonic request script 204H, and a completion marker 204I. The rendered flow control interface 206 is also newly rendered to include response selection control elements 206B. At first, contrary to the illustration of FIG. 2B, the flow control interface 206 may not be shown and the completion marker 204E is not marked.

The telephonic script 204H provides text which a claim associate can read or paraphrase to a claimant over the phone call to request the claimant to respond with preferences for a vehicle rental agency. In some examples, the telephonic script 204H may be automatically generated by inserting names of potential rental providers into a pre-defined text, as shown in FIG. 2B. After the claim associate has verbally explained this request, the claim associate can operate the client computing system to mark the completion marker 204I, whereupon the frontend application configures a display of the client computing system to display the response selection control elements 206B.

After the claimant responds to the claim associate's request, the claim associate can operate the client computing system to select one of several displayed options of the response selection control elements 206B, the options including more than one vehicle rental agency; an option indicating a vehicle rental agency other than the previous options; one or more options indicating no preference or no decision from the claimant; and an option indicating that the claimant does not wish to proceed to book a vehicle rental. The displayed options are claimant-specific possible responses to the claim associate's request. For the purpose of understanding example embodiments of the present disclosure, it is assumed that the claimant has verbally responded with any vehicle rental agency included among the options.

As illustrated in FIG. 2B, flow control elements 206 includes one or more options of the response selection control 206B, where one or more processors of the client computing system are configured to render options that correspond to multiple possible responses from the claimant so that the claim associate can operate the client computing system to select an option without inputting text. The completion marker 204I and the response selection control 206B, in conjunction, may configure one or more processors of the client computing system to render a view of the flow interface 204 illustrated in FIG. 2C.

FIG. 2C illustrates a third view of the flow interface 204 rendered by one or more processors of a client computing system configured according to example embodiments of the present disclosure. Though not shown in FIG. 2C, a display of the client computing system is configured to continue to display the persistent interface elements 202 and the flow indicator elements 208 including substantially similar elements as illustrated in FIG. 2A.

As illustrated in FIG. 2C, one or more processors of a client computing system are configured to render a flow interface element 204 containing one or more sub-elements as illustrated in FIG. 2B, an indication of rental agency selection 204J (e.g., selected using the response selection control 206B), and the flow control 206 comprising a proximity selection control 206C.

The claim associate can speak over a phone call to request the claimant to respond with preferences for rental proximity anchor: i.e., whether the claimant wishes to rent a vehicle nearest a repair facility to which a repair of the claimed vehicle is assigned, nearest a residence of the claimant, nearest a particular insurer branch office, nearest a particular zip code, or nearest a particular city.

After the claimant responds to the claim associate's request, the claim associate can operate the client computing system to select one of several options of the proximity selection control 206C, the options including a repair facility option; a residence option; a branch office option; a zip code option; and a city option. Such options are claimant-specific possible responses to the claim associate's request. For the purpose of understanding example embodiments of the present disclosure, it is assumed that the claimant has verbally responded specifying their repair facility as the proximity anchor (which requires no further specification of which repair facility, as the repair facility address in known for the selected participant of the particular vehicle rental claim, as discussed with reference to FIG. 2D). Similarly, any other selection from the proximity selection control 206C also corresponds to a known proximity anchor for the particular vehicle rental, and therefore, the claim associate does not need to type or enter such information.

As illustrated in FIG. 2C, the flow control element 206 provides options of the proximity selection control 206C that correspond to multiple possible responses from the claimant so that the claim associate can operate the client computing system to select an option without inputting text. A selection entered using the proximity selection control 206C configures one or more processors of the client computing system to render a view of the flow interface 204 illustrated in FIG. 2D, depending on the option of the proximity selection control 206C which has been selected (e.g., repair facility, in this example). In some examples, the claim associate may be provided with options to expand searches by changing search parameters such as location of the proximity anchor and/or a search radius around the proximity anchor.

FIG. 2D illustrates a fourth view of the flow interface 204 rendered by one or more processors of a client computing system configured according to example embodiments of the present disclosure. Though not shown in FIG. 2D, a display of the client computing system is configured to continue to display the persistent interface elements 202 and the flow indicator elements 208 including substantially similar elements as illustrated in FIG. 2A.

As illustrated in FIG. 2D, one or more processors of a client computing system are configured to render the flow interface element 204 containing one or more sub-elements as illustrated in FIG. 2C, in addition to a location anchor selection 204K indicating an address of the repair facility obtained from repair assignment data records returned from a repair management service API.

For example, in response to the claim associate selecting a repair facility option of the proximity selection control 206C, or at any time earlier in the service flow, one or more processors of the client computing system can query the API of the repair management service 106G using a policy number or a claim number as described above, causing the repair management service hosted at an organizational computing host to return a repair assignment data records containing one or more fields describing a repair facility to which repair of a vehicle covered by the policy number is assigned, or one or more fields describing a repair facility to which repair of a vehicle loss claimed according to the claim number is assigned.

One or more processors of the client computing system are configured to render the repair assignment data records at least in part, to identify an address of the repair facility. The claim associate need only verbally verify the repair facility address with the claimant over the phone call, and need not manually retrieve the repair facility address from other user interfaces, such as Internet browsers.

As an alternative example, in response to the claim associate selecting a residence option of the proximity selection control 206C, or at any time earlier in the service flow, one or more processors of the client computing system can query an API of the policy participants service 106C to retrieve the policy participant data record containing one or more fields describing a residence of the policy participant. Therefore, one or more processors of the client computing system may identify an address of the claimant from the policy participant data records, the claimant being the participant identified by the policy participant data record. The claim associate need only verbally verify the residence address with the claimant over the phone call; need not verbally request the address from the claimant or transcribe an address spoken by the claimant; and need not manually retrieve the residence address from other user interfaces of private hosted services.

As illustrated in FIG. 2D, the flow control element 206 includes a search button 206D rendered proximate to the location anchor selection 204K, where the claim associate can operate the client computing system to select the button 206D. Selecting the button 206D configures one or more processors of the client computing system to render a view of the flow interface 204 similar to the view illustrated in FIG. 2E.

FIG. 2E illustrates a fifth view of the flow interface 204 rendered by one or more processors of a client computing system configured according to example embodiments of the present disclosure. Though not shown in FIG. 2E, a display of the client computing system is configured to continue to display the persistent interface elements 202 and the flow indicator elements 208 including substantially similar elements as illustrated in FIG. 2A.

As illustrated in FIG. 2E, one or more processors of a client computing system are configured to render the flow interface element 204 containing one or more sub-elements as illustrated in FIG. 2D, in addition to rental locations 204L indicating one or more proximity search result data records obtained in response to a geographic proximity search using the location anchor selection 204K.

In response to the claim associate selecting the search button 206D as illustrated in FIG. 2D, one or more processors of the client computing system can query one or more rental agency lookup service APIs using a rental proximity anchor as described above, causing respective rental agency lookup services 118B hosted at the public computing hosts 118 of the selected rental agency to each return one or more proximity search result data records, each of these data records containing one or more fields describing a rental agency office which is among some number of offices nearest the rental proximity anchor.

It should be understood that one or more processors of the client computing system can query the rental agency lookup service 118B API directly, or by querying an API of the rental management service 106H using the proximity anchor, whereupon the rental management service 106H forwards the query to an API of the rental agency lookup service 118B.

It should be understood that different rental agencies can each operate their own respective rental agency lookup services, hosted at different public computing hosts; the client computing system, or an organizational computing host, are respectively configured to query each respective different rental agency lookup service API at a different public computing host.

The proximity search result data records include, at least in part, fields indicating addresses of particular offices of a rental agency, their respective phone numbers, their respective hours of operation (including whether each is open at the current time), and their respective distances from the rental proximity anchor.

Proximity search result data records are not displayed for offices of any rental agency which does not match the previously selected option of the response selection control 206B. Therefore, the claim associate can quickly review rental agency offices which match the claimant's preference, without reviewing rental agency offices which do not match the claimant's preference.

As illustrated in FIG. 2E, the flow control element 206 provides one or more office selection links 206E, where one or more processors of the client computing system are configured to render one office selection link for each rental agency office listed in the rental locations 204L from the proximity search result data records. Such office selection links are claimant-specific possible responses to the claim associate's request. Selecting a link of the office selection links 206E configures one or more processors of the client computing system to render a view of the flow interface 204 illustrated in FIG. 2F.

Since proximity search result data records do not include offices of any rental agency which does not match the previously selected option of the response selection control 206B, an office selection link is likewise not rendered for any such non-matching offices. Therefore, the claim associate can readily select one office from among those offices having office selection links rendered.

In this fashion, over the course of the service flow from FIG. 2B to FIG. 2F, the selective rendering of flow control elements which are claimant-specific possible responses anticipates the claim associate's search for nearby rental agencies and selection of an office of a rental agency on behalf of a claimant based on the claimant's preferences. The claim associate does not need to transcribe preferences of the claimant over a phone call, does not need to transcribe a rental proximity anchor selected by the claimant over a phone call, and does not need to open a separate user interface (such as a rental agency website in a Web browser) to input a rental proximity anchor and search for nearby rental agency offices. Rather, the frontend application configures one or more processors of a client computing system to anticipate claimant-specific possible responses among rental proximity anchors, anticipate possible rental agency lookup service APIs, and enable the claim associate to select a rental proximity anchor to expressly perform a lookup using a rental agency lookup service API using the selected rental proximity anchor.

Upon the claim associate operating the client computing system to select one of the office selection links 206E, one or more processors of the client computing system renders a view of the flow interface 204 illustrated in FIG. 2F.

FIG. 2F illustrates a sixth view of the flow interface 204 rendered by one or more processors of a client computing system configured according to example embodiments of the present disclosure. Though not illustrated in FIG. 2F, it should be understood that a display of a client computing system is configured to display the persistent interface elements 202 and the flow indicator elements 208 displaying substantially similar service flow parameters as illustrated in FIG. 2A.

As illustrated in FIG. 2F, one or more processors of a client computing system are configured to clear one or more previously described sub-elements from the rendered flow interface element 204, newly rendering in the flow interface element 204 sub-elements, the sub-elements including a selected rental location 204M from the proximity search result data records listed in rental location 204L, telephonic scripts 204N(1) and 204N(2), a completion marker 204O, one or more vehicle rental options 204P, and coverage options 204Q, and corresponding flow control 206 comprising option selection controls 206F

The rental location 204M shows the selected proximity search result data record in accordance with the claim associate's selection of an office display link 206E with reference to FIG. 2,E including, fields indicating an address of a particular office of a rental agency, its phone number, its hours of operation (including whether it is open at the current time), its distance from the proximity anchor, and the like.

The telephonic script 204N(1) and 204N(2) provides a script which a claim associate can read or paraphrase to a claimant over the phone call to request the claimant to respond with preferences for a vehicle rental option. In examples, a first script of the telephonic scripts (e.g., script 204N(1)) may be pre-defined, and a second script of the telephonic scripts (e.g., script 204N(2)) may be dynamically auto-generated e.g., using artificial intelligence (AI) chat tools. The AI tools may be provided with data from sub-elements 204M, 204P, 204Q etc. as inputs to generate the script including specific information from the service flow actions completed by the claim associate. For example, the first script 204N(1) may be pre-generated based on context within the service flow (e.g., if a next step of the service flow would require selection of a rental vehicle vendor, the script 204N(1) indicate that a selection is required), whereas the second script 204N(2) may be dynamically generated based on information received from the claimant, data from service flow actions completed by the claim associate, previously entered or known data, and the like.

In some examples, the one or more processors of the client computing system may maintain an indication of data that has already been viewed or made available to the claimants (e.g., during previous interactions). For example, if the claimant has already viewed options for rental vehicle vendors and/or has selected a provider, data related to rental vehicle vendors may be tagged to provide such indication. Such tags may be used during the generation of the telephonic script 204N(2).

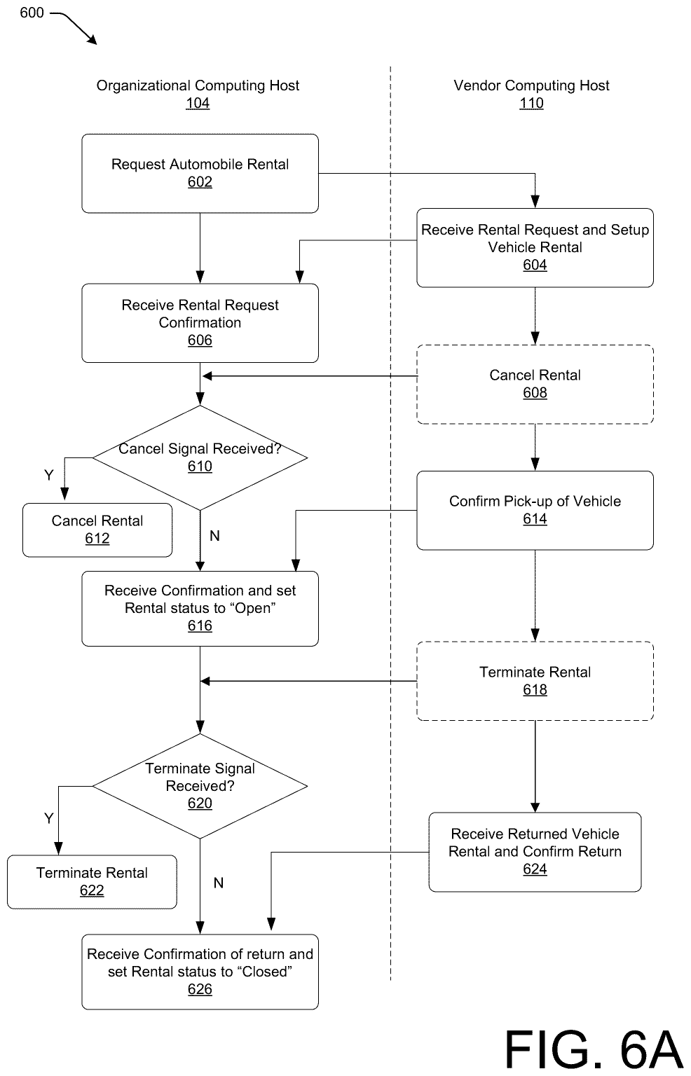

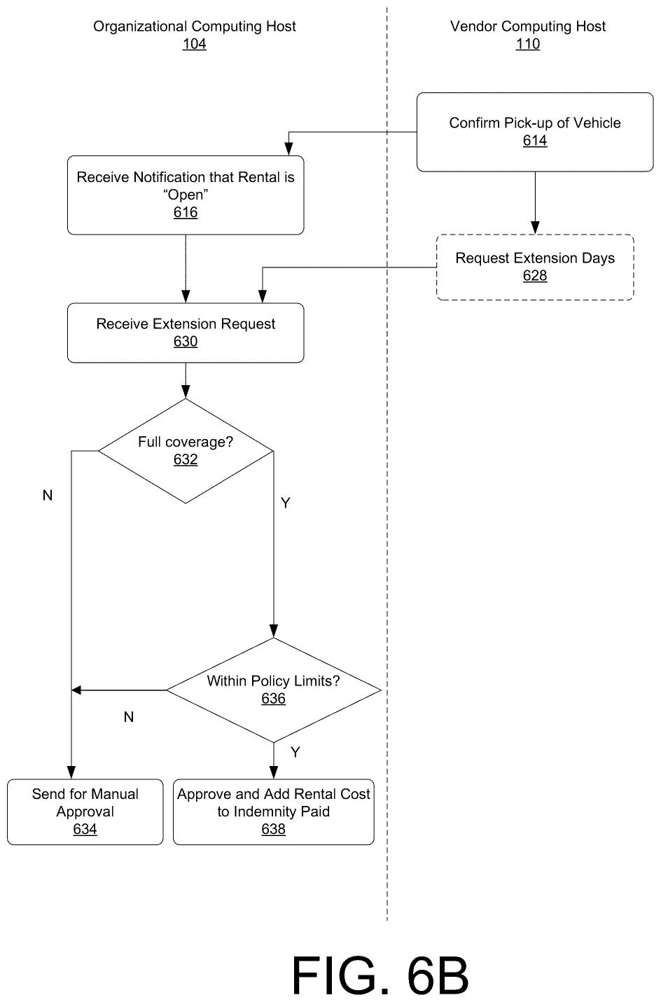

In examples, the telephonic script 204N(2) may be dynamically configured based on the information received from the claimant, and/or previously available or tagged information in relation to the claim or the insurance policy, whereas the telephonic request script 204N(1) may not be impacted by information obtained from the claimant during performance of the service flow actions. In examples, the telephonic request script 204N(2) may be selected based on a status of a damaged property or vehicle belonging to the claimant e.g., whether the vehicle is drivable, whether the vehicle or property is under repair, etc. An example of dynamic generation of the telephonic script 204N(2), based on information received and/or previously obtained, is described with reference to FIG. 6.

After the claim associate has verbally explained this request, the claim associate can further review the vehicle rental option data records displayed in vehicle rental options 204P, and read field values of each data record as displayed over the phone to the claimant. After the claim associate has read the field values of each data record, the claim associate can operate the client computing system to mark the completion marker 204O.

The frontend application configures one or more processors of the client computing system to query a rental booking service API based on the coverage data record, causing a rental booking service hosted at public computing hosts to return multiple vehicle rental option data records which are rendered in the vehicle rental options 204P., Each of these data records may contain one or more fields describing a class of vehicle which can be rented from the selected office of the rental agency under the coverage limits which is also displayed in the coverage level 204Q.

It should be understood that one or more processors of the client computing system can query an API of the rental booking service 118A directly, or by querying an API of the rental management service 106H using the coverage data record, whereupon the rental management service 106H forwards the query to the rental booking service 118A.

The vehicle rental options 204P are rendered in accordance with records returned by the rental booking service 118A. The vehicle rental options 204P and corresponding coverage levels 204Q includes, at least in part, specifications of a vehicle class; an estimated rental cost per day under coverage; an estimated rental cost per day outside of coverage; and a coverage duration as obtained from coverage data records.

As illustrated in FIG. 2F, flow control elements 206 includes option selection controls 206F, where one or more processors of the client computing system are configured to render options that correspond to each possible verbal rental vehicle selection from the claimant so that the claim associate can operate the client computing system to select an option without inputting text. Such options are claimant-specific possible responses to the claim associate's request. Each option selection control 206F further corresponds to a vehicle class, so that the claim associate can readily review and summarize classes of vehicles available to rent under the claimant's eligible coverage.

In examples, marking the completion marker 204O and selecting the option selection control 206F, in conjunction, configures one or more processors of the client computing system to activate a claim update control 206G, permitting it to be selected as illustrated in FIG. 2G. In some examples, the claim update control 206G for adding an item to the claim may be presented at a top of the user interface, and/or in additional areas of the user interface, such as at a bottom of the user interface, for convenient access by the claim associate. In some examples, the claim update control 206G may be displayed in an inactive state (e.g., in grey, and not allowing selection) in the user interface before activation.

After the claimant verbally responds to the claim associate's request over the phone call, the claim associate can operate the client computing system to select one of the option selection controls 206F, corresponding to a vehicle rental option verbally selected by the claimant. For the purpose of understanding example embodiments of the present disclosure, it is assumed that the claimant has verbally responded with any rental vehicle option included among the options. Selecting the option selection control 206F configures one or more processors of the client computing system to activate the claim update control 206G, permitting it to be selected as illustrated in FIG. 2G.

As illustrated in FIG. 2G, in addition to one or more sub-elements of the flow interface element 204 illustrated in FIG. 2F, the flow interface 204 may further include a rental summary sub-element 204R indicating data from the contract data record including, at least in part, a contract number, rental vehicle information, and contact information of the rental agency office which processed the rental booking. The flow interface 204 may also include a rental management progress indicator (not shown) reflecting the fact that the rental management service is now forwarding the vehicle rental contract to other private services hosted on the organizational computing hosts, causing the organizational computing hosts to perform assignment of the vehicle rental contract to the claimant. Details of such legal and financial liability assignment are beyond the scope of the present disclosure.

Upon the claim associate operating the client computing system to select the activated claim update control 206G, one or more processors of the client computing system renders a view of the flow interface 204 and the flow indicator 208 illustrated in FIG. 2H. One or more processors of the client computing system also causes the rental management service 106H to submit a rental booking request to the rental booking service API 118A, causing the rental booking service 118A to return a contract data record to the rental management service 106H (which is then returned by the rental management service 106H to the client computing system), reflecting that a vehicle rental contract has been generated on public computing hosts operated by the rental agency.

FIG. 2H illustrates another view of the flow interface 204 and the flow indicator 208 rendered by one or more processors of a client computing system configured according to example embodiments of the present disclosure. Though not illustrated in FIG. 2H, it should be understood that a display of a client computing system is configured to display the persistent interface elements 202 displaying substantially similar service flow parameters as illustrated in FIG. 2A.

As illustrated in FIG. 2H, the flow indicator 208 indicates, in the services status 212D, that the claim associate has started service flow actions for a vehicle rental for a second vehicle (e.g., V2) which may correspond to a vehicle of an external claimant. In examples, the view illustrated in FIG. 2H may be rendered after the vehicle rental assignment has been completed for a participant, using a service workflow illustrated in FIGS. 2B-G, and therefore, the services status 212B indicates a completed status. However, in other examples, the claim associate may perform the service flow actions for the second vehicle first, based on receiving a telephone call from the external claimant before the policy participant(s).

As illustrated in FIG. 2H, similar to FIG. 2A, one or more processors of a client computing system are configured to clear all previously described sub-elements from the rendered flow interface element 204, then newly render a flow interface element 204 containing sub-elements, which may be the same sub-elements shown in FIG. 2A after updating with current data. In some examples, the flow interface element 204 for handling rental claims from external claimants may include different content sub-elements and different interactive sub-elements, which may be similar to or different from the sub-elements for handling claims from the policy participants named in the insurance policy, as discussed with respect to FIGS. 2B through 2G.

For example, the sub-elements may include the service identifier 204A updated to indicate rental service for the second vehicle, the vehicle summary 204B updated with information relating to the second vehicle, the coverage summary 204C updated with coverage for external claimants, the cause-of-loss summary 204D, and the indemnity paid 204E updated with a total amount corresponding to a sum of amounts paid for each participant listed in the participants sub-element 204F. In some examples, the cause-of-loss summary 204D may display code(s) for external claimants that are different from the cause-of-loss summary shown in FIG. 2A for policy participants. The cause-of-loss code may indicate vehicle or property damage, or other types of claims, such as bodily injury, loss of income, and the like.

As illustrated in FIG. 2H, the participants sub-element 204F may include an entry for each external claimant, as identified by the role 204G shown in FIG. 2A, who was impacted by an accident with the insured vehicle, and suffered property of vehicle damage as a result. In examples, the external claimants may correspond to persons traveling in one or more vehicles, as well as pedestrians, cyclists, or other bystanders, impacted by the insured vehicle, and may also include entities such as businesses or corporations. As an example, if there are two vehicles involved in accident with the insured vehicle, and each of the vehicles carried two passengers, there may be four external claimants listed in the participants 204F who may need services such vehicle repair and/or rental transportation. As another example, the external claimant may also include a homeowner whose property (e.g., mailbox, garage door, etc.) suffered damage due to the accident.

The sub-elements may also include a status 204S indicating indemnity already paid to individual participants, including indemnity paid to the policy participants named in the insured policy. The indemnity paid sub-element 204E, which may be a sum of the indemnities paid to individual participants, enables the claim associate to review its value and compare, at a glance, the indemnity paid 204E with the coverage limits 202K of the insurance policy. In some examples, the sub-element 204E may visually indicate a result of the comparison e.g., by color coding such that the value appears red (or another first example color) if it is higher than the coverage limits 202K, yellow (or another second example color) if it is within a threshold of the coverage limits 202K, and green (or another third example color) if a difference between the value and the coverage limits 202K is higher than the threshold. Additionally or alternatively, a content sub-element providing a warning message to the claim associate may be provided when the value is within a threshold of the coverage limits 202K.

As also illustrated in FIG. 2H, the flow control element(s) 206 may provide interactive rental setup links 206H for external claimants listed in the participants 204F sub-element. As discussed with reference to FIG. 2A, the rental setup link(s) 206H configures one or more processors of the client computing system to render views of the multi-API interface 200 similar to the views illustrated in FIGS. 2B through 2G (showing the rental setup for policy participants), enabling the claim associate to select a rental vehicle provider and a corresponding rental location based on the claimant's preference (e.g., close to residence, repair facility, etc.) which may be obtained over the telephone. However, for rental setup for external claimants, there may be differences in the views and/or the service APIs that are called to obtain data. As an example, for an external claimant (e.g., who does not appear listed in the insurance policy), the service flow actions may return eligibility data record(s) without checking the rental coverage eligibility(ies) listed in the insurance policy.

According to example embodiments of the present disclosure, the private hosted services 106A-106I may return different data based on selections made by the claim associate indicating the type of claimant. For example, the cause of loss service 106B may return a first code for a policy participant and a second code, different from the first code, for an external claimant. As another example, the policy participants service 106C may return a list of policy participants records for the policy participants named in the insurance policy of the insurer. Whereas, for an external claimant, the policy participants service may return records related to external claimants that have filed claims under the insurance policy of one of the policy participants. In some examples, for an external claimant, the policy participants service may return such records without retrieving the list of policy participant records.

In examples the flow control element(s) 206 may also include a rental management link 206I for accessing and updating an active rental reservation for policy participants, in examples where the claim associate may already have completed a rental setup service for the participant. The view rendered in response to selection of the rental management link 206I is described with reference to FIG. 2J. As discussed, a rental vehicle service workflow for an external claimant may include differences from a rental vehicle service workflow for a policy participant. As an example, FIG. 2I shows a view of the flow interface 204 rendered during the rental vehicle service workflow for an external participant. As shown in FIG. 2I, the flow interface 204 may include one or more sub-elements previously described with reference to FIG. 2F, which may be updated with different content for external claimants. For example, the automatically generated text of the telephonic script 204N(2) may be different from the text displayed for policy participants shown in FIG. 2F.

As illustrated in FIG. 6I, which corresponds to the view from the service flow for policy participants illustrated in FIG. 2F, one or more processors of a client computing system are configured to clear all previously described sub-elements from the rendered flow interface element 204, newly rendering in the flow interface element 204 sub-elements, the sub-elements including the service identifier 204A, a selected rental location 204M, a telephonic script 204N(2), the vehicle rental options 204P, and the coverage level 204Q. However, the service flow for an external claimant may have differences from the service flow for policy participants, and these differences are reflected in the rendered flow interface 204 sub-elements shown in FIG. 2I. In some examples, in the service flow for the external claimant, the vehicle rental options 204P may list a limited selection of vehicle classes. As an example, the policy participants may be offered a rental vehicle of a vehicle class comparable to the insured vehicle, whereas the external claimant may be offered lower-end vehicle classes (such as economy and compact) which may be sufficient to remedy the external claimant's lack of transportation. In addition, the coverage level 204Q may indicate a number of days the vehicle rental is initially authorized for and a percentage cost of the vehicle rental. In some examples, the coverage level 204Q may be based on the coverage in the insurance policy for the policy participants, whereas for the external claimant, a default number of days (e.g., 25) may be initially authorized and the percentage covered may be set at a default value (e.g., 100%). In some examples, sub-elements of the flow interface element 204 may further include an interface usable by the claim associate to enter additional information 204T such as surcharge items like a car seat, fuel, additional insurance, a phone number for contacting the external claimant, and/or free-form textual comments. In some examples, some fields of the additional information 204T may be pre-populated. For example, a phone number for the claimant may already be available (e.g., from previous interactions with the claimant). In such an example, the one or more processors may display the phone number in the field, so that the claim associate does not need to query the claimant for their phone number. Instead, the claim associate may confirm the phone number with the claimant, and edit the field only if any changes are required. The one or more processors may also pre-populate the comments field indicating the claimant's previous selections. For example, if the claimant has a service provider selected for repairs, and/or a repair has already been scheduled, the one or more processors may populate the comments field with contact information (e.g., name, address, phone number, etc.) of the repair service provider. The fields of the additional information element 204T may be editable to allow the claim associate to make changes based on new information received from the claimant.

The flow control element 206 may provide rental option selection links 206F for selection, as also shown in FIG. 2G. Based on the rental option selection link 206F selected by the claim associate, the one or more processors of the computing host 104 may calculate a total rental expenditure (e.g., cost per day times authorized days). In some examples, one or more of the surcharge items listed in the additional information 204T may be required to be provided free of cost by state laws governing insurance policy coverage in a state e.g., the state where the accident occurred. The one or more processors of the client computing systems may access the requirements of the state, and include the required surcharge items in the rental cost to be paid by the insurer. The computing host 104 may update the total indemnity paid 204E and the status 204S corresponding to the external claimant (e.g., by adding the total rental expenditure to a previous value of the indemnity paid).

FIG. 2J illustrates an example view of the flow interface 204 in response to the claim associate selecting the manage rental link 206I, as described with reference to FIG. 2H. The view illustrated in FIG. 2J may be rendered for managing a vehicle rental that is in progress (e.g., has already been setup and a rental contract generated). As shown in FIG. 2J, the flow interface 204 may include various fields, such as the rental status 204S, the percentage of rental covered by the insurer 204U, a policy limit 204V, an extended days requested 204W, a current termination date of the rental 204X, and the like. Some of the fields may be editable by the claim associate, while other fields may be pre-populated and/or fixed. For example, the extended days requested 204W field may indicate a non-editable number of days of extension requested, which may have been received e.g., from the vendor computing host 116 or during a previous interaction with the claimant. The claim associate may be able to authorize a number of extension days by editing a field authorizing the extension 204Y. In examples, the termination date field 204X may be updated in response to the number entered in the authorization of extension field 204W. The claim associate may also be able to add comments in a comments field 204Z e.g., indicating whether an extension has been authorized or denied, and/or reasons related to an authorization.

Though the example service flows are described using examples of a policy participant service flow and an external claimant service flow, it can be understood that other claim associate workflows (or service flows) can be implemented in the flow control elements 206, where selective rendering of sub-elements of the flow control elements 206 may correspond to claimant type-specific tasks to be performed by the claim associate. As discussed, the sub-elements may be user interface (UI) elements of the frontend application, and the sub-elements may be configured dynamically to handle the workflow specific to the type of claimant. For example, the workflow (or service flow) may be selected based on an input from the claim associate, which may be based on the claim associate's determination of type of claimant (e.g., based on their phone conversation with the claimant). As a non-limiting example, type of claimant may further include whether the claimant was a driver of the vehicle or a passenger, as well as whether a police report indicates a fault-level of the claimant (e.g., DUI, not following traffic rules, etc.). Further, content presented in content-presentation sub-elements of the flow control elements 206 may be dynamically auto-generated (e.g., using artificial intelligence (AI) chat tools) by providing, as input, data from service flow actions completed by the claim associate sub-elements.

As described above, the frontend application running on a client computing system has configured one or more processors of the client computing system to assemble data records pertinent to a vehicle rental claim submitted by a claimant. In the course of booking a vehicle rental on behalf of the claimant, a claim associate needs to submit a variety of information to multiple private hosted service APIs and public hosted service APIs. In the event that the claim associate needs to request, transcribe, and manually input this information on a client computing system during telephonic services, substantial silences over the phone call could result, decreasing quality of the claimant's service experience. According to example embodiments of the present disclosure, a frontend application configures the client computing system to display a multi-API interface which anticipates information which the claim associate will need to send to multiple APIs, assembles this information from a variety of data records, and presents this information to the claim associate, using persistent interface elements, a flow interface element, and flow control elements which allow the claim associate to review and select information to send to multiple APIs with minimal distraction and interruption in the service flow of telephonic services.

Any number of client computing systems 102 operated by claim associates as described above can, by running a set of computer-executable instructions which configure the client computing systems 302 running a frontend application, connect to the networked computing hosts and send a request to the organizational computing hosts 104. The client computing systems 102, as configured by the frontend application, can then perform operations as described above.

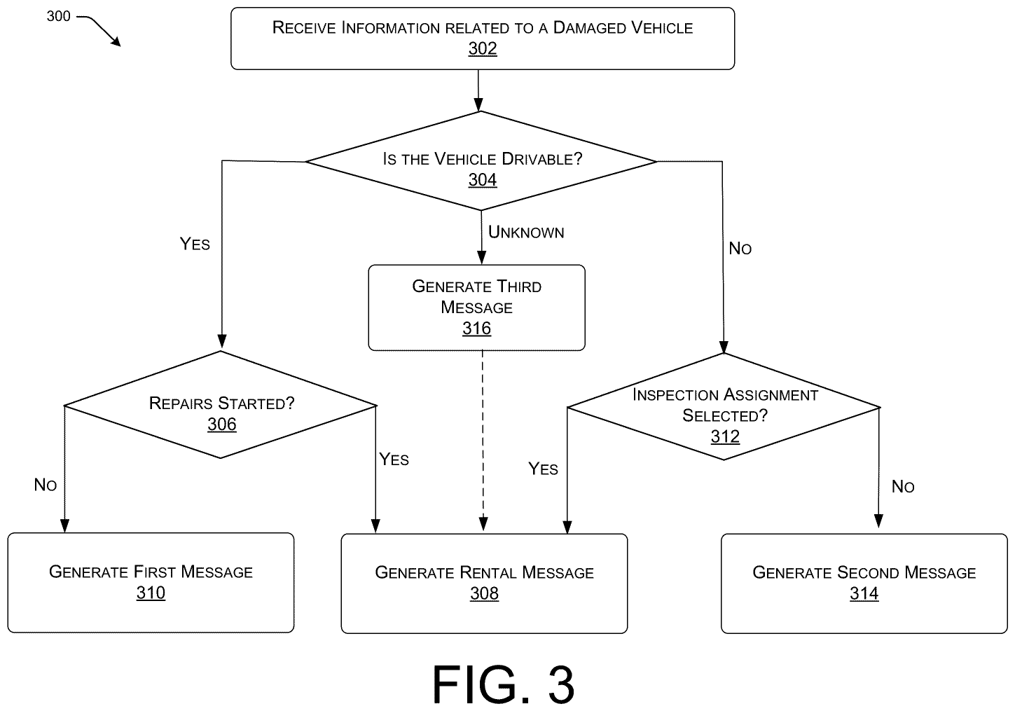

FIG. 3 illustrates an example process for generating scripts, such as the telephonic script 204N(2). In particular, the example illustrates generation of scripts to determine whether the claim associate may set up vehicle rentals for a claimant. As discussed with reference to FIGS. 2F and 2I, the telephonic script 204N(2) may be dynamically generated based on information received from the claimant, data from service flow actions completed by the claim associate, previously entered or known data, and the like. The generated scripts may be displayed as user interface (UI) elements of a frontend application supporting a service workflow of the claim associate.

At step 302, the process includes receiving information related to a damaged vehicle. In examples, the information may be received from a claimant during a telephonic conversation with the claim associate. In some examples, the information may be transcribed by speech-to-text processing to determine a status of the damaged vehicle e.g., whether the vehicle is drivable, whether repairs of drivable vehicles or inspection of undrivable vehicles have started, and the like. The information may also be received by accessing data from service flow actions previously completed by the claim associate or by accessing data that has been tagged as already viewed by the claimant. In some examples, the information may be received from other sources such as the insurance policy records, stored previous interactions associated with the claim, police reports, witness reports, and the like.

At step 304, the process includes determining, based on the information received, whether the damaged vehicle is drivable. If the damaged vehicle is drivable (“Yes” at step 304), at the step 306, the process includes determining, based on the information received, whether repairs have started on the damaged vehicle. If repairs have started on the damaged vehicle (“Yes” at step 306), then the process may, at a step 308, generate a rental message, such as the message 204N(2), indicating that the claimant may begin the process of selecting a rental vehicle vendor and/or a rental vehicle. The rental message may include preferred vendor information.

If repairs have not started (“No” at step 306), at step 310, the process may generate a first message. In some examples, the first message may indicate that for a drivable vehicle, the claimant may receive a rental vehicle only when a repair facility begins repairs on the damaged vehicle. In some examples, the first message may include personalized information such as the claimant's name, address, vehicle make/model/year, and the like. In some examples, the process may generate the first message by providing as input, to an artificial intelligence (AI) chat tool, the vehicle drivability and repair status, and/or the personalized information.

If the vehicle is not drivable (“No” at step 304), at step 312, the process includes determining, based on the information received, whether an inspection assignment, which assigns an entity responsible for a determination of whether the vehicle can be repaired to a drivable state, has been selected. If an inspection assignment has not been selected (“No” at step 312), at a step 314, the process includes generating a second message. In examples, the second message may indicate that the claimant may receive a rental vehicle only when an inspection assignment is selected. In some examples, the second message may also be generated using artificial intelligence (AI) chat tools and/or may include personalized information such as the claimant's name, address, vehicle make/model/year, and the like. If the inspection assignment has been selected (“Yes” at step 312), the process may, at the step 308, generate the rental message indicating options for the claimant to begin the process of selecting a rental vehicle.

In an example where it is not possible to determine if the vehicle is drivable from the received information (“Unknown” at step 304), the process may, at step 316, generate and display a third message. In some examples, the third message may include both the first message and the second message. Optionally, the process may generate the rental message at the step 308 after generating the third message.

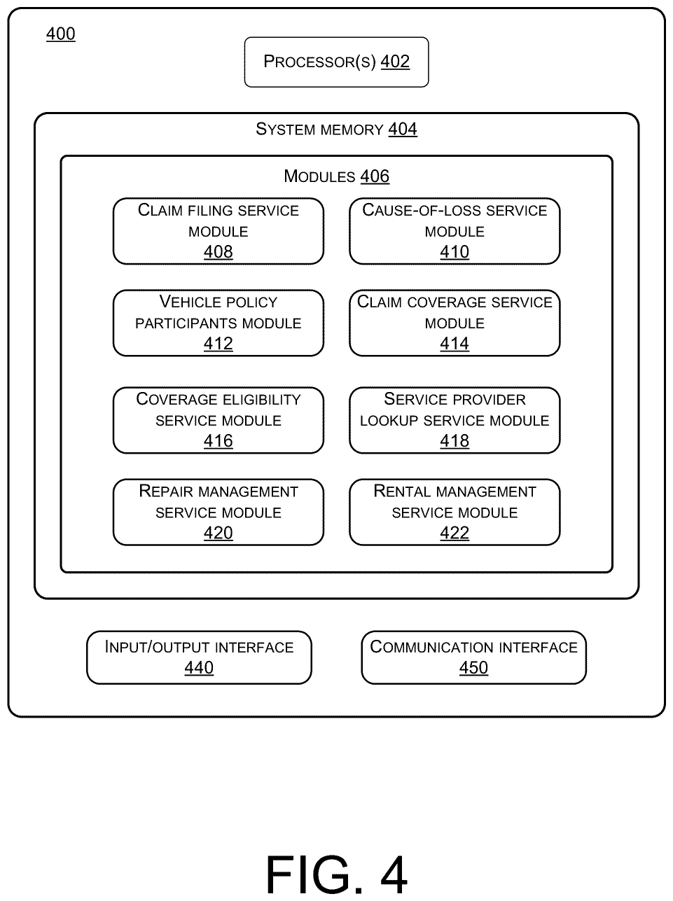

FIG. 4 illustrates an example computing host 400 for implementing the processes and methods described above for implementing private hosted services, such as the private hosted services 106.

The techniques and mechanisms described herein can be implemented by multiple instances of the computing host 400, as well as by any other computing device, system, and/or environment. The computing host 400 can be any varieties of computing devices, such as personal computers, personal tablets, mobile devices, and other such computing devices. The computing host 400 shown in FIG. 4 is only one example of a system and is not intended to suggest any limitation as to the scope of use or functionality of any computing device utilized to perform the processes and/or procedures described above. Other well-known computing devices, systems, environments and/or configurations that can be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The computing host 400 can include one or more processors 402 and system memory 404 communicatively coupled to the processor(s) 402. The processor(s) 402 and system memory 404 can be physical or can be virtualized and/or distributed. The processor(s) 402 can execute one or more modules and/or processes to cause the processor(s) 402 to perform a variety of functions. In embodiments, the processor(s) 402 can include a central processing unit (“CPU”), a graphics processing unit (“GPU”), any combinations thereof, or other processing units or components known in the art. Additionally, each of the processor(s) 402 can possess its own local memory, which also can store program modules, program data, and/or one or more operating systems.

Depending on the exact configuration and type of the computing host 400, the system memory 404 can be volatile, such as RAM, non-volatile, such as ROM, flash memory, miniature hard drive, memory card, and the like, or some combination thereof. The system memory 404 can include one or more computer-executable modules 406 that are executable by the processor(s) 402.

The modules 406 can include, but are not limited to, any number of modules which can configure one or more processors to perform the functions of private hosted service APIs as described above with reference to FIGS. 1, and 2A-2J, including a claim filing service module 408, a cause-of-loss service module 410, a vehicle policy participants module 412, a claim coverage service module 414, a coverage eligibility service module 416, a service provider lookup service module 418, a repair management service module 420, and a rental management service module 422.

The computing host 400 can additionally include an input/output (“I/O”) interface 440 and a communication module 450 allowing the computing host 400 to communicate with other systems and devices over a network, such as other computing hosts of the service cloud network as described above. The network can include the Internet, wired media such as a wired network or direct-wired connections, and wireless media such as acoustic, radio frequency (“RF”), infrared, and other wireless media.

Some or all operations of the methods described above can be performed by execution of modules, a module including any number of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media can include volatile memory (such as random-access memory (“RAM”)) and/or non-volatile memory (such as read-only memory (“ROM”), flash memory, etc.). The computer-readable storage media can also include additional removable storage and/or non-removable storage including, but not limited to, flash memory, magnetic storage, optical storage, and/or tape storage that can provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media can embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, can perform operations described above with reference to FIGS. 1 and 2A-2J. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

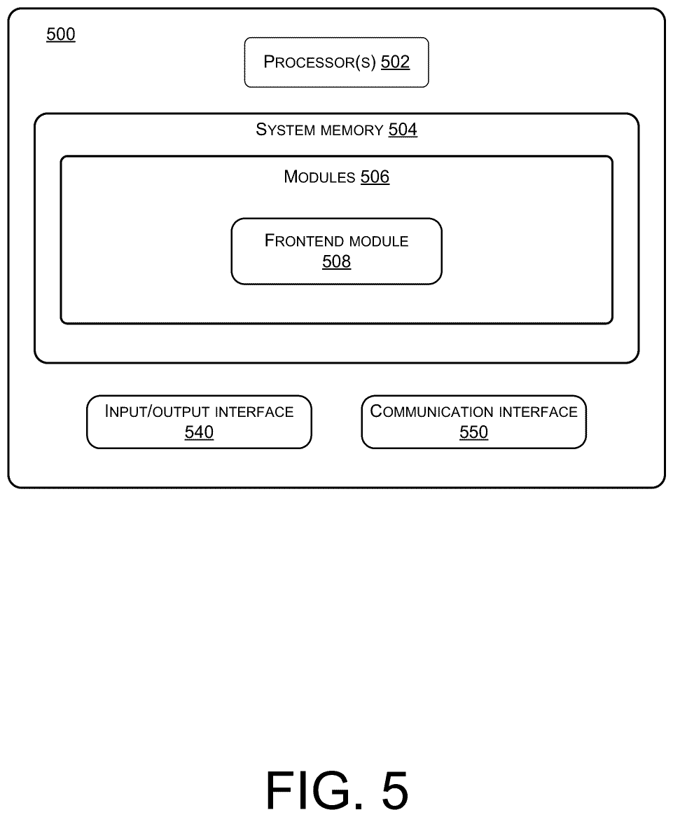

FIG. 5 illustrates an example client computing system 500 for implementing the processes and methods described above as configured by a frontend application.

The techniques and mechanisms described herein can be implemented by multiple instances of the client computing system 500, as well as by any other computing device, system, and/or environment. The client computing system 500 can be any varieties of computing devices, such as personal computers, personal tablets, mobile devices, and other such computing devices. The client computing system 500 shown in FIG. 5 is only one example of a system and is not intended to suggest any limitation as to the scope of use or functionality of any computing device utilized to perform the processes and/or procedures described above. Other well-known computing devices, systems, environments and/or configurations that can be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The client computing system 500 can include one or more processors 502 and system memory 504 communicatively coupled to the processor(s) 502. The processor(s) 502 and system memory 504 can be physical or can be virtualized and/or distributed. The processor(s) 502 can execute one or more modules and/or processes to cause the processor(s) 502 to perform a variety of functions. In embodiments, the processor(s) 502 can include a central processing unit (“CPU”), a graphics processing unit (“GPU”), any combinations thereof, or other processing units or components known in the art. Additionally, each of the processor(s) 502 can possess its own local memory, which also can store program modules, program data, and/or one or more operating systems.

Depending on the exact configuration and type of the client computing system 500, the system memory 504 can be volatile, such as RAM, non-volatile, such as ROM, flash memory, miniature hard drive, memory card, and the like, or some combination thereof. The system memory 504 can include one or more computer-executable modules 506 that are executable by the processor(s) 502.

The modules 506 can include, but are not limited to, a frontend module 508 which can configure one or more processors to perform the functions of a frontend application as described above with reference to FIGS. 1 and 2A-2J. The frontend 508 can be hosted on a computing host 400 and run remotely on the computing host 400 as a service for the client computing system 500 over one or more network connections; however, the computer-executable instructions making up the frontend module 508 can be downloaded to system memory 504 to the client computing system 500 and run locally at the client computing system 500.

The client computing system 500 can additionally include an input/output (“I/O”) interface 540 and a communication module 550 allowing the computing host 400 to communicate with other systems and devices over a network, such as a computing host 400 of the service cloud network as described above. The network can include the Internet, wired media such as a wired network or direct-wired connections, and wireless media such as acoustic, radio frequency (“RF”), infrared, and other wireless media.

FIGS. 6A and 6B illustrate flowcharts of an example interaction 600 between a computing system of an insurer, such as the organizational computing host 104, and a computing system of a vendor, such as the vendor computing host 116, during a vehicle rental transaction. In examples, the interaction 600 may be based on selections of the claim associate in the flow control 206 elements of FIGS. 2A-2J, and may be conducted by calls to APIs of the public hosted services 118 and the private hosted services 106. For example, the interaction 600 may be started by the claim associate selecting an option selection control 206F indicating a vehicle choice and rental location 204M which may be forwarded to an API of the rental booking service 118A of the public hosted services 118 on a vendor computing host 116.

In examples, the organizational computing host 104 may track a status of the rental transaction (e.g., based on a step of the interaction 600) using status indicators listed in Table 1 below.

TABLE 1

| Rental Status | Definition |
|---|---|
| New/Requested (REQ) | A request was submitted for a rental reservation to the vendor |
| | system by the insurer computing system. |
| Confirmed (CNF) | Vendor system sent a confirmation that the request has been |
| | received and a vehicle is available. |
| Open (OPN) | Vendor system sent a notification confirming that the claimant has |
| | picked up the vehicle from the vendor location. |
| Cancelled (CAN) | The request to cancel has been sent by either the vendor system or |
| | the insurer computing system. A cancel may only occur if the |
| | vehicle has not been picked up by the claimant. |
| Terminated (TRM) | A request to terminate the rental has been sent by either the vendor |
| | system or the insurer computing system. A termination may only |
| | occur once the vehicle is picked up by claimant. |
| Closed (CLS) | Vendor system sent a request to close a reservation after the |
| | claimant has returned the vehicle to the vendor location. |
| Rejected (REJ) | Vendor system sent an error notification indicating that a request |
| | made by the insurer computing system has been rejected (along |
| | with an error code indicating a type of reason e.g., technical error, |
| | business error, warning, etc.) |

At step 602, the organizational computing host 104 may send an automobile rental request to the vendor computing host 116 e.g., via a call to the API of the rental booking service 118A, and set a rental status to “Requested.” The automobile rental request may include a selection of rental vehicle, dates of rental, location of pickup, and other information entered by the claim associated via the multi-API interface 200, as described with reference to FIGS. 2A-2J.

At step 604, the vendor computing host 110 may receive the rental request and setup a vehicle rental in accordance with the request. The vendor computing host 110 may send a confirmation message to the organizational computing host 104 in response to receiving the rental request. The confirmation message may also include a unique identifier identifying the rental transaction in progress.

At step 606, the organizational computing host 104 may receive the rental request confirmation sent from the vendor computing host 110 at the step 604, and set the rental status to “Confirmed.” In some examples, in response to receiving the rental request confirmation, the organizational computing host 104 may forward the confirmation to the client computing systems 102, and the multi-API interface 200 may render a rental summary in the flow interface 204, such as the rental summary 204R illustrated in FIG. 2G.

In some examples, the vendor computing host 110 may cancel the rental at a step 608 (e.g., due to unavailability of the rental vehicle which may be caused by the vehicle needing repairs or not being returned on time). The organizational computing host 104, may at a step 610, check if a cancel signal is received from the vendor computing host 110, and if “Yes” at the step 610, cancel the rental at a step 612 by setting a status of the rental to “Cancelled.”

If the rental transaction is not canceled, the vendor computing host 110 may, at a step 614, send a confirmation of pick-up of the vehicle after the claimant has picked up the rental vehicle, thus starting the rental period.

At step 616, the organizational computing host 104 may receive the confirmation sent at the step 614 that the rental vehicle has been picked up, and set the rental status to “Open.” The rental transaction may be accessed by a claim associate by using the manage rental link 206I when the rental status is set to “Open.”

In some situations, the vendor computing system 110 may send a terminate rental signal at a step 618 after the rental vehicle has been picked up. In some examples, the terminate rental signal may instead be received from the client computing systems 102. At step 620, the organizational computing host 104 may check if a terminate signal has been received, and if “Yes,” may terminate the rental at a step 622, and set the rental status to “Terminated.”

If the vehicle rental is not terminated, the vendor computing system 110 may, at step 624, confirm return of the rental vehicle after receiving the rental vehicle at the rental location. When the organizational computing system 104 receives, at step 626, the confirmation that the rental vehicle has been returned, the organizational computing system 104 may set the rental status to “Closed.” The organizational computing system 104 may compute a rental cost based on the duration of rental, type of vehicle, and other costs. Further, the organizational computing system 104 may set up payment for the rental cost to the rental agency, and update data in sub-elements of the multi-API interface 200, such as the indemnity paid 204E amount, the amount shown in the status 204S, etc.

FIG. 6B illustrates an alternative scenario where the vendor computing host 110 sends, after confirming the pick-up of the rental vehicle at the step 614, a request for extension of rental at a step 628. The organizational computing host 104 may receive, at step 630, the request for extension of the rental. In some examples, the request for extension may be received from the client computing system 102 (e.g., as entered by a claim associate based on an interaction with the claimant).

At step 632, the organizational computing host 104 may determine whether the rental is covered in full under the insurance policy e.g., by accessing coverage data via calls to APIs of the claim coverage service 106D and/or the coverage eligibility service 106E. In examples, if the rental is not covered in full (“No” at step 632), the organizational computing host 104 may send the extension request for manual review and approval at a step 634. For example, the coverage indicated in the insurance policy may be an 80/20 coverage where 80% of the rental cost is covered by the insurance, and 20% is required to be paid by the claimant.

Alternatively, if the rental is covered in full (“Yes” at step 632), the organizational computing host 104 may check, at step 636, if an additional cost of the extension request would be within policy limits of the insurance policy (e.g., whether a maximum coverage amount is exceeded if the additional cost of the extension is added to the current costs and/or indemnity already paid).

If the cost of the extension is within policy limits (“Yes” at step 636), the extension request may be automatically approved by the organizational computing host 104 and added to the indemnity payments at step 638. Alternatively, if the cost of the extension exceeds the policy limits (“No” at step 636), the extension request may be sent for manual review and approval at the step 634. For example, if the extension requested add $300 to the rental costs, the indemnity already paid amounts to $1300, and the policy limit is $1500, the cost ($1600) exceeds the policy limit, and therefore, is sent for manual approval at step 634.

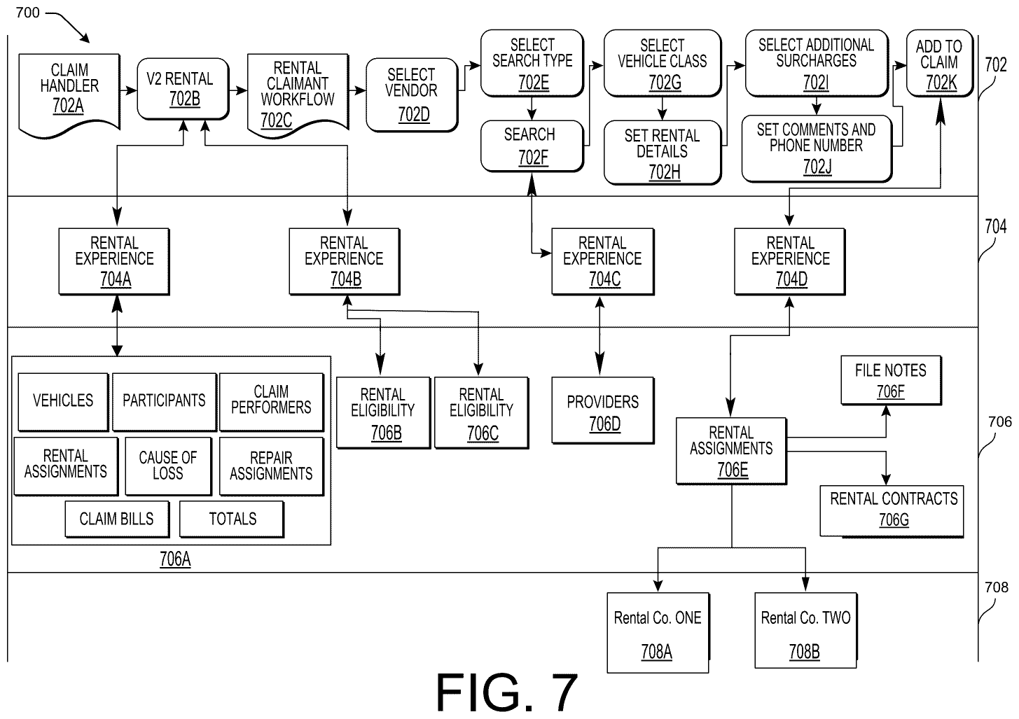

FIG. 7 illustrates a schematic diagram of an example computing architecture 700 implementing example embodiments of the present disclosure e.g., rental vehicle assignment for claimants. Example embodiments of the computing architecture 700 may be implemented on networked computing hosts communicating over one or more private networks, as described with reference to FIG. 1. The computing architecture 700 may include a workflow implemented by one or more processors of a client computing system 702 (similar to the client computing system 102), the workflow including steps 702A-702K which may correspond to views of the multi-API interface 200, as illustrated in FIGS. 2A-2J. For example, a claim handler at a starting step 702A may determine an incoming claim, identify a damaged vehicle for which a rental is required at step 702B, and identify a claimant for a rental vehicle workflow at step 702C. Further, a vendor (e.g., rental agency) may be selected at step 702D, a search for a rental agency office may be conducted at step 702E, a vehicle class may be selected at step 702G, rental details (e.g., particular vehicle selected) may be determined at step 702H, additional surcharges may be identified at step 702I, comments and additional information (e.g., phone number of a renter) may be added at step 702J, and the vehicle rental arranged in the steps 702A-J may be added to an insurance claim at step 702K. A frontend application delivering views corresponding to the steps may be controlled by rental experience APIs 704A-704D of a user experience API layer 704, and may provide, to the claim associate, output(s) of calls to APIs 706A-706E of an API layer 706. The APIs 706A-706E may provide access to data and computation necessary for completing the steps of the workflow and store output documents in file notes 706F and rental contracts 706G. The experience API layer 704 and the API layer 706 may be implemented on the organizational computing hosts 104 described with reference to FIG. 1. One or more of the APIs 706A-706E may communicate with computing system(s) 708A, 708B of external vendors 708 (e.g., rental vehicle providers, repair shops).

As an example, the workflow step 702B corresponds to a start of a rental vehicle assignment for a claimant, which may be an external claimant or a policy participant. During the step 702B, the client computing system 702 may make calls to the APIs 706A to fetch initial data associated with the insurance policy, the insured vehicle, cause-of-loss, indemnity already paid, and the like. Additionally, or alternatively, the client computing system 702 may make calls to at least one of the APIs 706B and 706C, to fetch a list of participants and their rental eligibility. Outputs returned by the APIs 706A-C may be used to populate corresponding fields of the view illustrated in FIG. 2A or FIG. 2H, user interface elements of the view being controlled by the rental experience APIs 704A and 704B. As another example, at step 702F, the client computing system 702 may issue a call to fetch a list of rental vehicle providers to the API 706D, the API 706D returning output that may be populated into the view illustrated in FIG. 2B.

After the claim associate adds a rental vehicle using the claim update control 206G (as shown in FIG. 2G) at step 702K, the client computing system 702 may issue a call to the API 706E to transmit rental information (e.g., vehicle class, location, dates, etc.) to an external vendor computing system e.g., 708A, 708B, to reserve the rental vehicle. The client computing system 702 may also provide, to the external vendor computing systems 708A, 708B repair information of the damaged vehicle associated with the claimant via the API 706E. For example, a message transmitted to the external vendor computing systems 708A, 708B may include information indicating whether the damaged vehicle is currently under repair or a date when the repair is scheduled. In some examples, dates of reservation of the rental vehicle are based on the repair information e.g., the rental vehicle is provided starting on the date repair commences. The API 706E may save the rental information, as the file notes 706F and the rental contracts 706G, in one or more databases, and return a confirmation message to the workflow step 702K. In some examples, the file notes 706F may be generated to record events such as addition of extension days, cancellations, and/or actions taken by the claim associate. In some examples, the events may trigger an action to be taken by the claim associate e.g., a request for additional rental days may be notes in the file notes 706F and trigger a review by the claim associate.

Though the example computing architecture 700 is described using an example of a rental vehicle reservation, it can be understood that other claim associate workflows performing other tasks related to insurance claims processing may be implemented using the architecture 700, where the workflow is performed on the client computing system 702, steps of the workflow making calls to APIs and user experience APIs of the API layers 704, 706 hosted by the organizational computing hosts of the insurer, and one or more of the APIs 704 accessing external vendor computing systems 708 if necessary to perform the step(s). Some or all operations of the methods described above can be performed by execution of modules, a module including any number of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media can include volatile memory (such as random-access memory (“RAM”)) and/or non-volatile memory (such as read-only memory (“ROM”), flash memory, etc.). The computer-readable storage media can also include additional removable storage and/or non-removable storage including, but not limited to, flash memory, magnetic storage, optical storage, and/or tape storage that can provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, digital versatile disks (“DVD”) or other optical storage, magnetic cassettes, magnetic tape, magnetic disk storage or other magnetic storage devices, or any other non-transmission medium that can be used to store information for access by a computing device. In contrast, communication media can embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, can perform operations described above with reference to FIGS. 1, and 2A-2J. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
providing, by a client computing system, a frontend application including a first rendering of a user interface (UI), the first rendering of the UI comprising:
a persistent interface element, and
a flow interface element including a first plurality of sub-elements,
the frontend application selectively displaying a first flow control element in the first rendering based on a current step of a service flow;
receiving, by the client computing system, information indicative of an interaction with the first flow control element, wherein the information is based on an input received from a user of a user device; and
providing, by the client computing system and based on the information, a second rendering of the UI, the second rendering comprising:
the persistent interface element,
the flow interface element including a second plurality of sub-elements, and
a second flow control element associated with a next step of the service flow.

2. The method of claim 1, wherein the first flow control element is rendered proximate to first indicia of claimants eligible for vehicle rental coverage associated with an automobile insurance policy.

3. The method of claim 1, wherein the second plurality of sub-elements includes a telephonic script and a completion marker, the method further comprising:
receiving, by the client computing system, an indication of an interaction with the completion marker; and
based on receiving the indication, providing, by the client computing system, a response selection control as a component of the second rendering, the response selection control corresponding to the next step.

4. The method of claim 1, further comprising:
querying, by the client computing system, a repair management service API using a policy number or a claim number;
receiving, by the client computing system and from the repair management service, a repair assignment data record including an address of a repair facility; and
providing, by the client computing system, the address of the repair facility among the second plurality of sub-elements in the flow interface element,
wherein a second flow control element is rendered proximate to the address, the address being selectable as input to the next step.

5. The method of claim 4, further comprising:
querying, by the client computing system, a rental agency lookup service API using the address as a proximity anchor;
receiving, by the client computing system and from the rental agency lookup service, a plurality of proximity search result data records, each record of the plurality of proximity search result data records containing one or more fields describing a rental agency office located within a predetermined distance from the proximity anchor; and
providing, by the client computing system, the plurality of proximity search result data records among the second plurality of sub-elements in the flow interface element,
wherein the second flow control element comprises an office selection link for each of the plurality of proximity search result data records.

6. The method of claim 1, further comprising:
providing, by the client computing system, from a policy participant data record, a residence address associated with the user,
wherein the second flow control element is rendered proximate to the residence address.

7. The method of claim 6, further comprising:
querying, by the client computing system, a rental agency lookup service API using the residence address as a proximity anchor;
receiving, by the client computing system, based on the querying, and from the rental agency lookup service API, a plurality of proximity search result data records, each record of the plurality of proximity search result data records containing one or more fields describing a rental agency office which is located within a predetermined distance from the proximity anchor; and
providing, by the client computing system, the plurality of proximity search result data records among the second plurality of sub-elements in the flow interface element,
wherein the second flow control element comprises an office selection link for each of the plurality of proximity search result data records.

8. The method of claim 1, wherein:
the second plurality of sub-elements includes content-presentation sub-elements displaying textual content, and
the textual content is based at least in part on insurance policy records and the current step.

9. The method of claim 8, wherein the textual content is generated by an artificial intelligence (AI) chat tool.

10. The method of claim 1, wherein the next step is based on a claimant type of the user, the claimant type being at least one of: a policy participant or an external claimant.

11. The method of claim 10, further comprising:
querying, by the client computing system, a rental agency lookup service API with the claimant type and an associated address;
receiving, by the client computing system and from the rental agency lookup service, a plurality of rental vehicle options based on the claimant type; and
providing, by the client computing system, a third plurality of sub-elements in the flow interface element, the third plurality of sub-elements including a listing of the plurality of rental vehicle options.

12. The method of claim 1, wherein the information is a first information and the interaction is a first interaction, the method further comprising:
receiving, by the client computing system, second information indicative of a second interaction with the second flow control element;
clearing, by the client computing system, the second plurality of sub-elements from the flow interface element in response to the second information; and
providing, by the client computing system, a third rendering of the UI comprising the persistent interface element and the flow interface element including a third plurality of sub-elements, the third plurality of sub-elements being associated with a further step of the service flow.

13. A computing system, comprising:
a display;
a processor operably connected to the display; and
a memory communicatively coupled to the processor, the memory storing a set of instructions that, when executed by the processor, cause the processor to perform operations comprising:
providing, on the display, a frontend application including a first rendering of a user interface (UI), the first rendering of the UI comprising:
a persistent interface element,
a flow interface element including a first plurality of sub-elements, and
a first flow control element based on a current step of a service flow;
receiving information indicative of an interaction with the first flow control element, wherein the information is based on an input received from a user of a user device;
clearing the first plurality of sub-elements from the flow interface element in response to the interaction; and
providing, based on the information, a second rendering of the UI, the second rendering comprising:
the persistent interface element,
the flow interface element including a second plurality of sub-elements, and
a second flow control element associated with a next step of the service flow.

14. The computing system of claim 13, wherein the second plurality of sub-elements includes a telephonic script and a completion marker, the operations further comprising:
receiving an indication of an interaction with the completion marker; and
based on receiving the indication, providing a response selection control as a component of the second flow control element, the response selection control corresponding to the next step.

15. The computing system of claim 13, the operations further comprising:
querying a rental agency lookup service API using an address associated with the user as a proximity anchor;
receiving, from the rental agency lookup service, a plurality of proximity search result data records, each record of the plurality of proximity search result data records containing one or more fields describing a rental agency office located within a predetermined distance from the proximity anchor; and
providing the plurality of proximity search result data records among the second plurality of sub-elements in the flow interface element,
wherein the second flow control element comprises a selection link for each of the plurality of proximity search result data records.

16. The computing system of claim 13, wherein the second plurality of sub-elements includes a content-presentation sub-element, and the operations further comprising:
generating, based on a type of the user and the current step, textual content to be displayed in the content-presentation sub-element, wherein the type is one of: a policy participant or an external claimant.

17. The computing system of claim 13, the operations further comprising:
querying a rental agency lookup service API with user data associated with the user;
receiving, from the rental agency lookup service, a plurality of rental vehicle options based on the information; and
providing, a third plurality of sub-elements in the flow interface element, the third plurality of sub-elements including a listing of the plurality of rental vehicle options.

18. A computer-executable storage medium storing computer-readable instructions executable by one or more processors, that when executed by the one or more processors, cause the one or more processors to perform operations comprising:
providing a frontend application including a first rendering of a user interface (UI) comprising:
a persistent interface element,
a flow interface element including a first plurality of sub-elements, and
a first flow control element based on a current step of a service flow;
receiving information indicative of an interaction with the first flow control element, wherein the information is based on an input received from a user of a user device;
clearing the first plurality of sub-elements from the flow interface element in response to the interaction; and
providing, based on the information, a second rendering of the UI, the second rendering comprising:
the persistent interface element,
the flow interface element including a second plurality of sub-elements, and a second flow control element associated with a next step of the service flow.

19. The computer-readable storage medium of claim 18, wherein the second plurality of sub-elements includes a telephonic script and textual content to be displayed as the telephonic script is generated automatically based at least in part on user data associated with the user and the current step.

20. The computer-readable storage medium of claim 19, wherein generating the telephonic script comprises:
receiving an identification of a damaged vehicle of the user associated with an insurance claim;
determining, based on the identification, a status of the damaged vehicle, wherein the status includes either a first indication that the damaged vehicle is drivable, or a second indication that the damaged vehicle is undrivable;
generating, based on the status, either a first message corresponding to the first indication, or a second message, different from the first message, corresponding to the second indication; and
displaying, via the UI, the first message or the second message as the telephonic script.
